(19) United States
(12) Patent Application Publication
(10) Pub. No.: US 2002/0166063 A1
(43) Pub. Date: Nov. 7, 2002

(54) System and method for anti-network terrorism

(75) Inventors: John Paul Lachman III, Singer Island, FL (US); Mansi Hsieh, Los Angeles, CA (US)

Correspondence Address: KING & SPALDING, 191 PEACHTREE STREET, N.E., ATLANTA, GA, 30303-1763, US

(73) Assignee: Cyber Operations, LLC, Jupiter, FL

(21) Appl. No.: 10/086,107

(22) Filed: Feb. 28, 2002

Related U.S. Application Data
(60) Provisional application No. 60/272,712, filed on Mar. 1, 2001.

(51) Int. Cl. H04L 9/00

(52) U.S. Cl. 713/200; 713/188

(57) ABSTRACT

Protecting a host network from a flood-type denial of service attack by passively collecting a data packet from data received by the host network, comparing information in the data packet to a signature of an attack type of the attack, and detecting the attack in response to a determination that the signature and the information comprise matching data. A defensive countermeasure can be initiated to protect the host network from the attack and to provide a pathway for an offensive countermeasure against a source of the attack.

### PRIORITY APPLICATION

This application claims the benefit of priority to U.S. Provisional Patent Application Serial No. 60/272,712, entitled “System and Method for Anti-Network Terrorism,” filed Mar. 1, 2001. The complete disclosure of the above-identified provisional patent application is fully incorporated herein by reference.

### FIELD OF THE INVENTION

The present invention relates generally to a system and method for detecting and countering a network attack. More particularly, the present invention relates to a passive network attack detection system and method with proactive countermeasure technology that can prevent network flood interruptions without disrupting normal network operations.

### BACKGROUND OF THE INVENTION

The security of computing networks is an increasingly important issue. With the growth of wide area networks (WANs), such as the Internet and the World Wide Web, people rely on computing networks to transfer and store an increasing amount of valuable information. In today's computing environment, companies, schools, organizations, and other enterprises ordinarily operate a host network to communicate and store electronic documents and information. Each host network typically provides access to other host networks or wide area networks allowing an increased flow of information.

Attacks on host network computer systems are an increasing problem for e-commerce companies, network communications providers, organizations, and governments. In a “denial of service” (DOS) attack on a host network, an attacker attempts to prevent legitimate users from accessing services provided by a particular host network. DOS attacks can essentially disable a single computer or an entire host network. Such a disruption in service can be costly to the host network provider in terms of lost revenue, repair costs, and lost productivity during the disruption.

DOS attacks come in a variety of forms and aim at a variety of services. Computers and networks require network bandwidth, memory, disk space, CPU time, and access to other computers and networks to operate. Attacks on a host network can disrupt any of those items to be effective. Typically, an attacker executes a DOS attack against the host network's connectivity to prevent the host network from communicating outside its environment.

One way to attack the host network's connectivity involves exploiting flaws in the TCP stack. The attacker establishes a connection to a victim computer of the host network. However, the attacker establishes the connection in such a way as to prevent the ultimate completion of the connection. In the meantime, the victim computer has reserved one or more of a limited number of data structures required to complete the impending connection. Accordingly, the attack denies legitimate connections while the victim computer waits to complete each “half-open” connection.

Another method for initiating a denial of service attack involves exploiting security holes in an existing network to gain access. Once inside the network, the attacker can disrupt network service by attacking the network connectivity.

In today's network environment, the most problematic type of DOS attack includes “flooding” a host network with information. The flood of information can consume all available bandwidth of the host network's computing resources, thereby preventing legitimate network traffic from reaching the host network and preventing an individual user from accessing the services of the host network. The attacker can consume bandwidth through a network flood by generating a large number of packets, or a small number of extremely large packets, directed to the target network. Typically, those packets comprise Internet control message protocol (ICMP) ECHO packets, a user datagram protocol (UDP) stream attack, or a TCP SYN flood. In principle, however, the packets can include any form.

The attacker can execute the flood attack from a single computer. Alternatively, the attacker can coordinate or co-opt several computers on different networks to achieve the same effect. Using several computers for an attack is commonly referred to as a distributed denial of service (DDOS) attack. The attacker can also falsify (spoof) the source IP address of the packets, thereby making it difficult to trace the identity of computers used to carry out the attack. Spoofing the source IP address also can shift attention onto innocent third parties.

An attacker also can execute a more defined attack using spoofed packets called “Broadcast Amplification” or a “Smurf attack.” In this common attack, the attacker generates packets with a spoofed source address of the target. The attacker then sends a series of network requests using the spoofed packets to an organization having many computers. The packets contain an address that broadcast the packets to every computer at the organization. Every computer at the organization then responds to the spoofed packet requests and sends data to the target site. Accordingly, the target becomes flooded with the responses from the organization. Additionally, the target site may blame the organization for the attack.

Conventional methods for handling a DOS attack typically have focused on detecting an attack that exploits security holes or establishes half-open connections. For example, a conventional intrusion detection system (IDS) can detect an attacker's entry into a server. Such a system typically operates on the server itself and can detect only an entry into the specific server. Additionally, a conventional IDS cannot detect and counter a flood-type DOS attack.

Conventional firewall and router techniques also exist for attempting to handle problems associated with a flood attack. However, conventional firewall techniques also are insufficient to detect and counter a flood-type DOS attack. Firewall techniques typically involve comparing a header of incoming data packets to specific, known flood attacks. However, hundreds of specific, known flood attacks exist, and comparing the packet information to each attack can require a significant amount of time. Accordingly, such a process costs valuable response time before taking action to protect the network, which can allow the network to become overwhelmed by the incoming packets. Additionally, conventional firewall techniques cannot detect an unknown or new attack.

Conventional router techniques also are insufficient to detect and counter a flood-type DOS attack. A conventional router can monitor peak traffic flow. If the traffic flow exceeds a specified amount, then the router will limit the traffic flowing through it, thereby maintaining traffic flow below the specified limit. However, that technique limits only the traffic flow through the router. It does not prevent traffic from reaching the router. Accordingly, a large number of requests can back up at the router in the event of a flood-type DOS attack. Eventually, the traffic flow becomes choked and the router shuts down. Furthermore, conventional router techniques only evaluate traffic flow and cannot detect or counter a flood attack. When the router limits traffic flow, the attacking packets still arrive at the router, contributing to the choking problem discussed above.

Accordingly, there is a need in the art for a system and method that can detect and counter a flood-type DOS or DDOS attack. Specifically, a need exists for a system and method that can passively monitor incoming data packets and can detect the DOS/DDOS flood attack in a short time period. Early detection can allow a fast response, which can limit the attack's effect on a host network. A further need exists for detecting the flood attack based on a signature of an attack type, rather than based upon specific, known attacks. Additionally, a need exists for a system and method that can detect and counter a new, unknown attack type. In this regard, a need exists for a system and method that can learn and generate a signature for the unknown attack type, thereby allowing future use of the learned signature. Furthermore, a need exists in the art for a system and method that can monitor incoming data packets for a number of routers on a host network and that can detect a flood attack on any of the routers. A need also exists for a central monitoring station that can monitor the detection and countering of a flood attack on each router. Finally, a need exists in the art for a system and method that can proactively initiate an offensive or defensive countermeasure against the flood attack.

### SUMMARY OF THE INVENTION

The present invention can provide a system and method for detecting and countering a flood-type DOS attack. The present invention can learn DOS/DDOS attack types corresponding to a number of specific attacks. An attack can then be detected by determining if incoming data packets include an attack type signature. The present invention can also detect an attack by comparing incoming data packets to determine if they include similar or matching information. If the detected attack does not have an associated attack type signature, then the present invention can analyze the new attack and learn its attack type signature for future use. The present invention can also confirm an attack through load capacity analysis prior to initiating a countermeasure.

The present invention can also provide a system and method for countering a flood-type DOS attack. By determining whether the attack was initiated from a single source or multiple sources, the present invention can counter the attack without disrupting normal system operations. If the attack was initiated from a single source, then the present invention can prevent data packets having the attacking source IP address from reaching the host server. If the attack was initiated from multiple sources, then the present invention can prevent data packets having the target IP address from reaching the host server. The present invention can also provide a pathway for controlling and initiating an offensive strike or counter attack.

One aspect of the present invention relates to a computer-implemented method for protecting a host network from a flood-type denial of service attack. The method can include the steps of comparing information in an incoming data packet to a signature of an attack type of the attack and detecting the attack in response to a determination that the signature and the information comprise matching data. Alternatively, the method can include the steps of comparing information in incoming data packets and detecting the attack in response to a determination that a pair of the incoming data packets comprise similar information.

Yet another aspect of the present invention relates to a computer-implemented method for generating a signature of a network attack type. The attack type can correspond to a flood-type denial of service attack or to other types of network attack. The method can include the step of identifying a repetitive pattern in the information of at least two data packets of the attack type.

Still another aspect of the present invention relates to a computer-implemented method for countering a flood-type denial of service network attack. The method can include the steps of reading an attacking source IP address from the attacking data packet and preventing an incoming data packet comprising the attacking source IP address from entering a host network through a host router. Alternatively, the method can include the steps of reading an attack target IP address from one of a plurality of attacking data packets and preventing an incoming data packet having the attack target IP address from entering a host network through a host router.

Another aspect of the present invention relates to a system for protecting a host network from attack. The system can include a database operable for storing a signature for an attack type of the attack, a packet sniffing module operable for collecting a data packet from data received by a host router, and a decision module operable for detecting the attack by determining whether information in the data packet matches the signature stored in the database. Alternatively, the system can include a packet sniffing module operable for collecting a plurality of data packets from data received by a host router and a decision module operable for detecting the attack by determining if any pair of data packets comprise similar information.

These and other aspects, objects, and features of the present invention will become apparent from the following detailed description of the exemplary embodiments, read in conjunction with, and reference to, the accompanying drawings.

### BRIEF DESCRIPTION OF THE DRAWINGS

FIG. 1 is a block diagram depicting a representative operational environment of an anti-network terrorism system constructed in accordance with an exemplary embodiment of the present invention.

FIG. 2 is a block diagram depicting an anti-network terrorism system according to an exemplary embodiment of the present invention.

FIG. 3 is a flow chart depicting a method for detecting and countering a network attack according to an exemplary embodiment of the present invention.

FIG. 4 is a flow chart depicting an initialization method according to an exemplary embodiment of the present invention.

FIG. 5 is a flow chart depicting a method for generating a signature for an attack type according to an exemplary embodiment of the present invention.

FIG. 6 is a flow chart depicting a method for detecting a network attack according to an exemplary embodiment of the present invention.

FIG. 7 is a flow chart depicting a method for learning a signature of a new attack type according to an exemplary embodiment of the present invention.

FIG. 8 is a flow chart depicting a method for initiating a defensive countermeasure according to an exemplary embodiment of the present invention.

FIG. 9 is a flow chart depicting a method for initiating a defensive countermeasure for a single source attack according to an exemplary embodiment of the present invention.

FIG. 10 is a flow chart depicting a method for initiating a defensive countermeasure for a multiple source attack according to an exemplary embodiment of the present invention.

FIG. 11 illustrates a main page graphical user interface (GUI) for overall system operations according to an exemplary embodiment of the present invention.

FIG. 12 illustrates an exemplary downed interfaces screen for the GUI illustrated in FIG. 11.

FIG. 13 illustrates an exemplary down interface screen for the GUI illustrated in FIG. 11.

FIG. 14 illustrates an exemplary options screen for the GUI illustrated in FIG. 11.

FIG. 15 illustrates an exemplary restart screen for the GUI illustrated in FIG. 11.

FIGS. 16A and 16B illustrate an exemplary configuration screen for the GUI illustrated in FIG. 11.

FIG. 17 illustrates a main screen GUI for a central monitoring station (CMS) according to an exemplary embodiment of the present invention.

FIG. 18 illustrates exemplary file menu options for the GUI illustrated in FIG. 17.

FIG. 19 illustrates an exemplary new file dialog window for the file menu options illustrated in FIG. 18.

FIG. 20 illustrates an exemplary open dialog window for the file menu options illustrated in FIG. 18.

FIG. 21 illustrates an exemplary save as dialog window for the file menu options illustrated in FIG. 18.

FIG. 22 illustrates exemplary edit menu options for the GUI illustrated in FIG. 17.

FIG. 23 illustrates an exemplary “Insert Root Item” dialog window for the edit menu options illustrated in FIG. 22.

FIG. 24 illustrates an exemplary “Insert Child Item” dialog window for the edit menu options illustrated in FIG. 22.

FIG. 25 illustrates an exemplary “Edit Item” dialog window for the edit menu options illustrated in FIG. 22.

FIG. 26 illustrates an exemplary “Ant Config Page” dialog window for the edit menu options illustrated in FIG. 22.

FIG. 27 depicts exemplary countermeasure menu options for the GUI illustrated in FIG. 17.

FIG. 28 illustrates an exemplary “Set Countermeasure Box” dialog window for the countermeasure menu options illustrated in FIG. 27.

FIG. 29 is a flow chart depicting a method for secure communications between an anti-network terrorism server and a countermeasure server according to an exemplary embodiment of the present invention.

FIG. 30 depicts exemplary window menu options for the GUI illustrated in FIG. 17.

FIG. 31 illustrates an exemplary access control list manager window for the window menu options illustrated in FIG. 30.

FIG. 32 illustrates an exemplary “Add/Edit Item” dialog window for the access control list manager window illustrated in FIG. 31.

FIG. 33 illustrates an exemplary “Downed IP Editor” for the window menu options illustrated in FIG. 30.

FIG. 34 illustrates exemplary help menu options for the GUI illustrated in FIG. 17.

FIG. 35 illustrates an exemplary MRTG graph for the GUI illustrated in FIG. 17.

FIG. 36 illustrates an exemplary ACMS log window for the GUI illustrated in FIG. 17.

FIG. 37 illustrates an exemplary ACMS main screen having an “Alert” message displayed due to a detected DOS attack.

FIG. 38 illustrates an exemplary ACMS main screen having an “Exploit” warning due to a detected exploit attack.

FIG. 39 illustrates an exemplary countermeasure control screen for the main screen illustrated in FIG. 38.

FIG. 40 is a flow chart depicting a method for secure message communications between the central monitoring station and an anti-network terrorism server according to an exemplary embodiment of the present invention.

### DETAILED DESCRIPTION OF EXEMPLARY EMBODIMENTS

The present invention can provide a passive detection system with proactive countermeasure deployment technology, which can prevent denial of service (DOS) and distributed denial of service (DDOS) flood interruptions without disrupting normal network operations. The present invention can reside in front of the firewall system architecture and can include the ability to learn DOS/DDOS attack types. Additionally, the present invention can include an anti-network terrorism (A.N.T.) server that can act on a stand-alone basis or that can work in unison with other A.N.T. servers through direct or Internet connections. A.N.T. servers working in unison can learn from the experiences of each other. A central monitoring station (CMS) can manage multiple A.N.T. servers deployed throughout a large network infrastructure. The present invention can provide both a defensive and offensive countermeasure capability to respond to network flood attacks or to launch an offensive .

The system according to the present invention can monitor data packets for data content through the use of software that essentially analyzes network traffic. That method can provide the system with the ability to monitor traffic transmitted and received by the host system. Additionally, network administrators can establish data load thresholds on both the inbound and outbound traffic flows, resulting in the ability to differentiate between normal and abnormal network behavior. If the system detects an attack, the load threshold can be used to confirm the attack prior to initiating a countermeasure.

Although the exemplary embodiments will be generally described in the context of software modules running in a distributed computing environment, those skilled in the art will recognize that the present invention also can be implemented in conjunction with other program modules for other types of computers. In a distributed computing environment, program modules may be physically located in different local and remote memory storage devices. Execution of the program modules may occur locally in a stand-alone manner or remotely in a client/server manner. Examples of such distributed computing environments include local area networks of an office, enterprise-wide computer networks, and the global Internet.

The detailed description which follows is represented largely in terms of processes and symbolic representations of operations in a distributed computing environment by conventional computer components, including database servers, application servers, mail servers, routers, security devices, firewalls, clients, workstations, memory storage devices, display devices and input devices. Each of these conventional distributed computing components is accessible via a communications network, such as a wide area network or local area network.

The processes and operations performed by the computer include the manipulation of signals by a client or server and the maintenance of these signals within data structures resident in one or more of the local or remote memory storage devices. Such data structures impose a physical organization upon the collection of data stored within a memory storage device and represent specific electrical or magnetic elements. These symbolic representations are the means used by those skilled in the art of computer programming and computer construction to most effectively convey teachings and discoveries to others skilled in the art.

The present invention also includes a computer program which embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement the disclosed invention based on the flow charts and associated description in the application text, for example. Therefore, disclosure of a particular set of program code instructions is not considered necessary for an adequate understanding of how to make and use the invention. The inventive functionality of the claimed computer program will be explained in more detail in the following description in conjunction with the remaining figures illustrating the program flow.

Referring now to the drawings, in which like numerals represent like elements throughout the figures, aspects of the present invention and the preferred operating environment will be described.

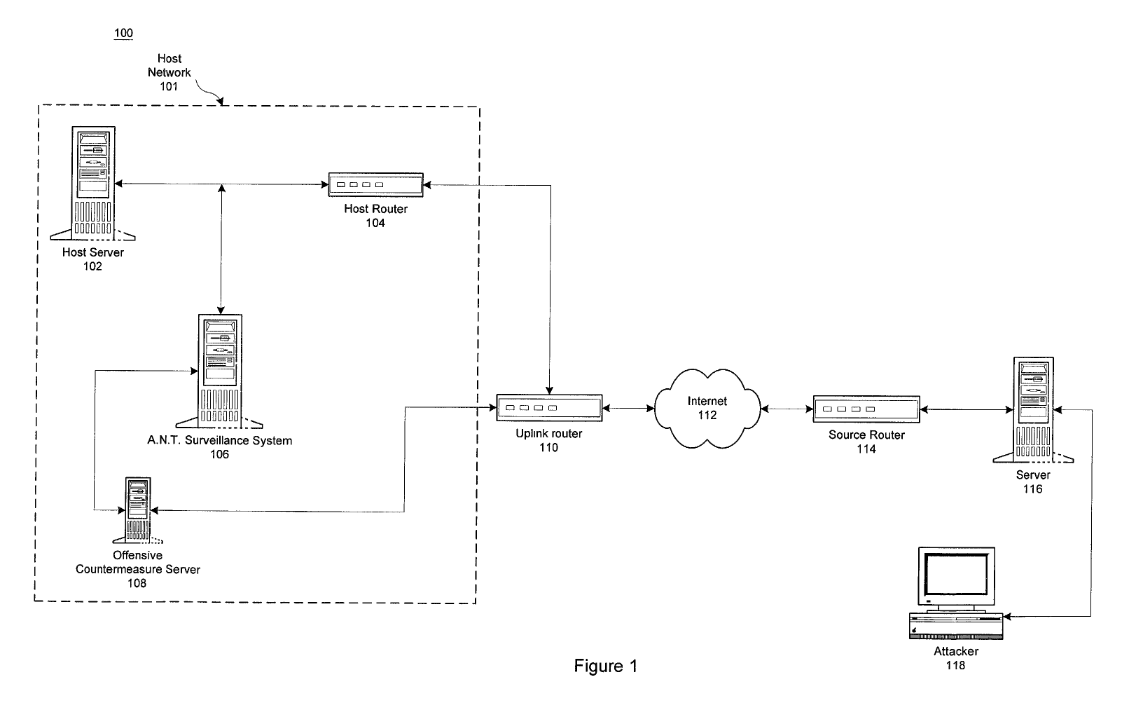

FIG. 1 is a block diagram depicting a representative operational environment 100 of an anti-network terrorism (A.N.T.) system constructed in accordance with an exemplary embodiment of the present invention. As shown in FIG. 1, a host network 101 can include a host server 102 and a host router 104. Host router 104 can be coupled to the Internet 112 by an uplink router 110 that provides Internet services to host network 101. Additionally, an attacker 118 can connect to host system 101 through the Internet 112. Typically, attacker 118 connects to a server 116. From server 116, data from attacker 118 travels to a source router 114 across Internet 112 to uplink router 110. From uplink router 110, data from attacker 118 can be transferred to host router 104 of host network 101.

To prevent data from attacker 118 from reaching host server 102, host network 101 can include an A.N.T. system 106 according to an exemplary embodiment of the present invention. System 106 can connect to host network 101 between host router 104 and host server 102. Accordingly, system 106 can monitor data sent between host router 104 and host server 102 to detect a flood type DOS attack, as well as other types of attack. The exemplary system 106 can be positioned in front of a firewall (not shown) of host system 101. After system 106 detects an attack, it can activate a defensive countermeasure at host router 104 to protect host network 101 from the attack.

Additionally, system 106 can be connected to an offensive countermeasure server 108, which can provide a pathway for initiating an offensive countermeasure against attacker 118. In this regard, system 106, together with offensive countermeasure server 108, can provide a management platform to control and initiate any available offensive capability. External programs can be integrated into, and launched from, system 106 to implement an offensive countermeasure. Offensive countermeasure server 108 can be located within host network 101 as shown in FIG. 1. Alternatively, offensive countermeasure server can be located outside of the architecture of host network 101 (not shown), which can hide the identity of host network 101 when initiating an offensive countermeasure.

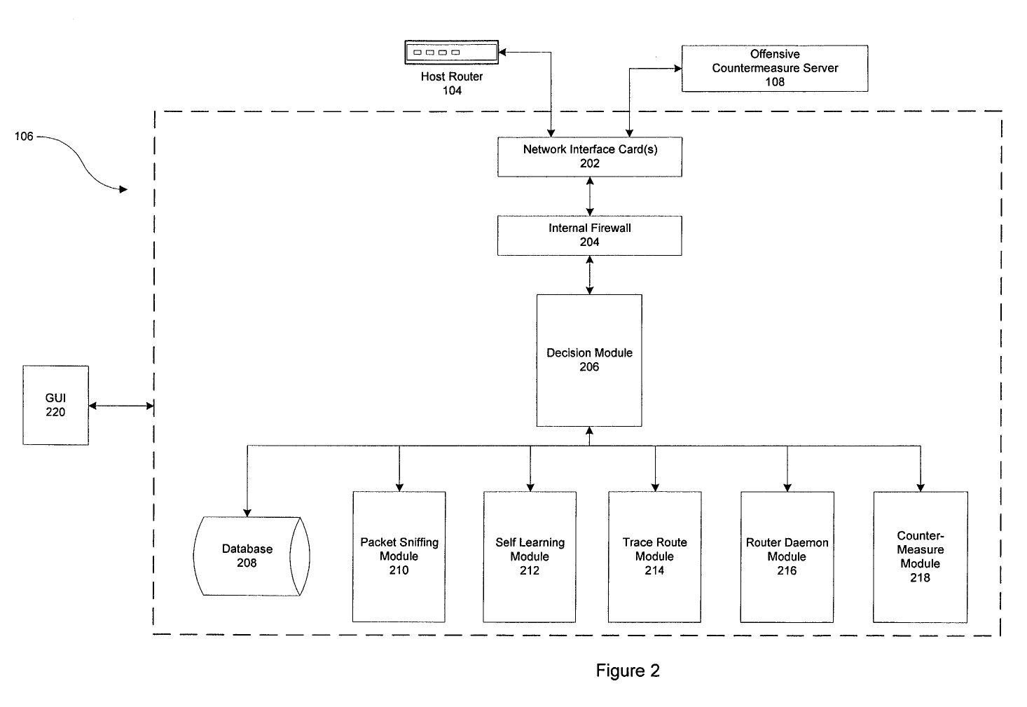

FIG. 2 is a block diagram depicting the system 106 according to an exemplary embodiment of the present invention. System 106 can include one or more network interface cards 202 for connecting system 106 to host router 104 and offensive countermeasure server 108. An internal firewall 204 can be provided between network interface card 202 and decision module 206. Decision module 206 can determine whether host network 101 (FIG. 1) is under attack. Decision module 206 interacts with database 208 and modules 210-218 to perform various functions for detecting and countering a network attack.

Database 208 can store signatures representing known types of network attack. Signatures of attack types are different from signatures for specific attacks and will be discussed further below. Packet sniffing module 210 can collect and analyze data packets transferred from host router 104 to host server 102. Packet sniffing module 210 can compare information in the data packets to the signatures stored in database 208 to detect a flood-type DOS attack against host network 101. Packet sniffing module can also compare information within packets to detect packets comprising similar or matching information, thereby detecting a flood attack.

Self-learning module can identify and generate a signature for an attack type. Additionally, if host network 101 is attacked by a new attack type without a known signature, then self-learning module 212 can learn the signature of the new attack type. The new signature can then be stored in database 208 for future use. Once an attack has been detected, decision module 206 can verify the attack by determining if the current network load exceeds a specified load threshold. In that case, router daemon module 216 can interact with decision module 206 and host router 104 to verify the attack based on load capacity of host network 101. Additionally, decision module 206 can detect the attack based only on the load threshold.

Trace route module 214 can verify the source IP address of the attacking packets, can determine whether a single source or multiple sources produced the attack, and can determine whether the attack was initiated from a real or false IP address location. A false IP address is commonly referred to as a “spoofed” address. Attackers use spoofed address locations to conceal their true identity.

Countermeasure module 218 can then initiate a defensive countermeasure against either the single source or the multiple sources. Router daemon module 216 can interact with countermeasure module 218 to apply the countermeasure to an interface of host router 104 and to uplink router 110. Additionally, countermeasure module 218 can provide a pathway through offensive countermeasure server 108 for initiating an offensive countermeasure against an attack source.

Finally, a graphical user interface (GUI) 220 can be provided for allowing a user to interact with system 106.

The flow charts discussed below further describe the operation of the components depicted in FIG. 2.

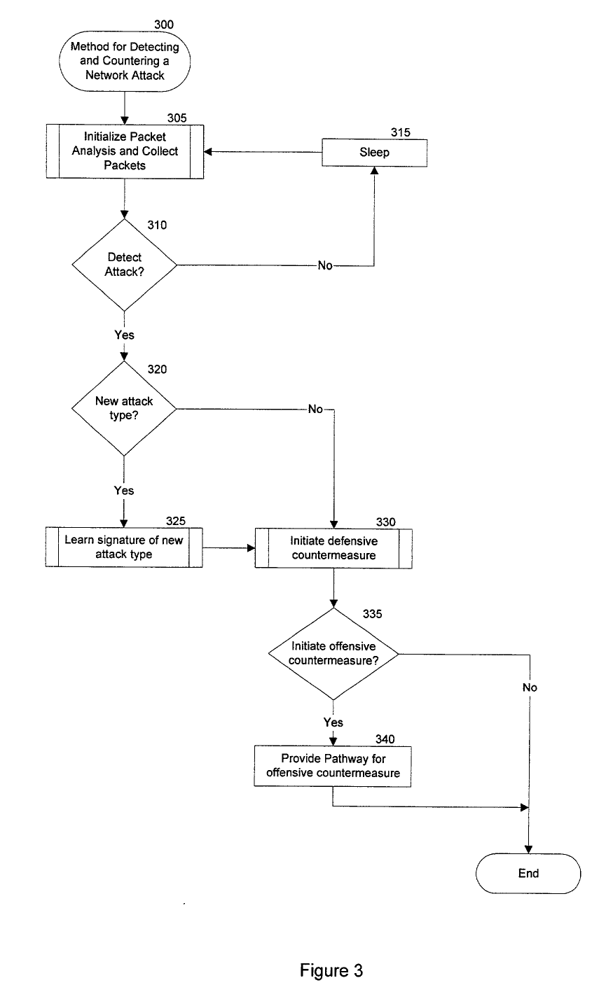

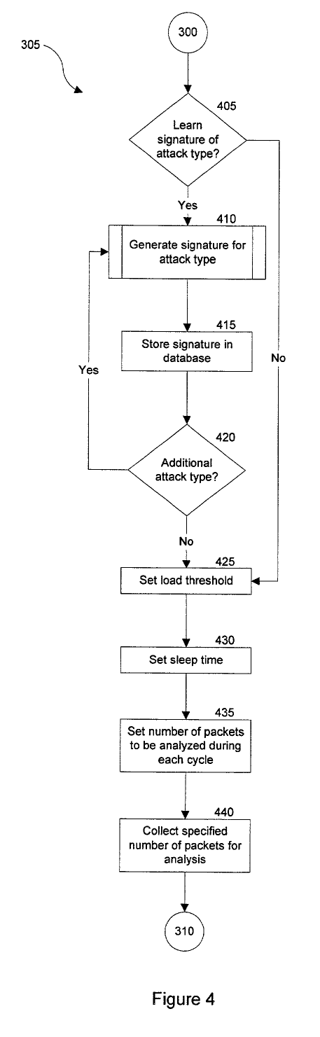

FIG. 3 is a flow chart depicting a method 300 for detecting and countering a network attack according to an exemplary embodiment of the present invention. In step 305, packet analysis can be initialized and packets can be collected for analysis. The initialization process can involve storing attack type signatures in database 208 and configuring certain parameters of the method, which will be discussed in connection with FIG. 4. In step 310, it can be determined whether decision module 206 has detected an attack upon host network 101. If decision module 206 has not detected an attack, then the method can branch to step 315.

In step 315, the method can sleep for a predetermined amount of time before returning to step 305 to analyze additional packets. Accordingly, the exemplary embodiment can transition to a sleep mode between listening cycles. The duration of the sleep cycle can be configurable. If the sleep time is set to zero, then the exemplary method will not pause at step 315 and packet analysis can be performed on a continuous basis. During the sleep time of step 315, changes to the configuration files can be reloaded and updated in real time via GUI 220.

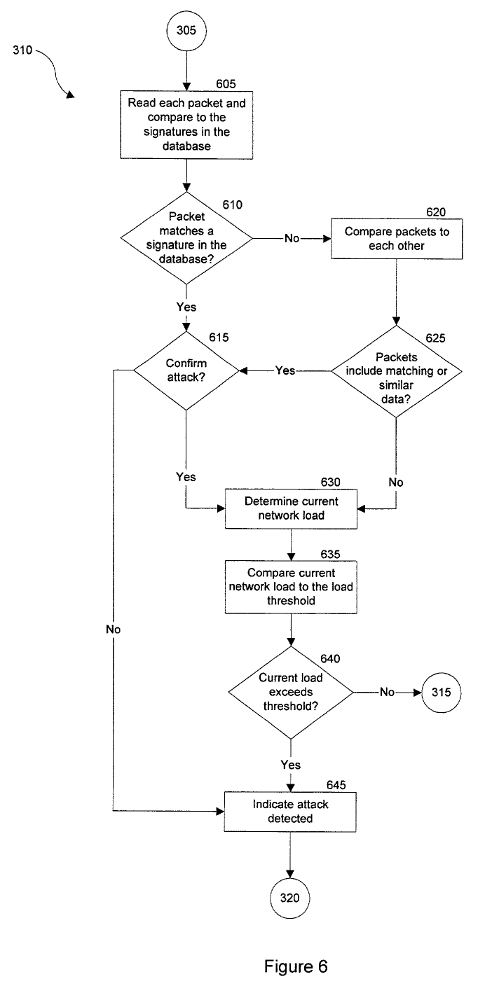

By collecting and analyzing a set number of packets during each cycle, system 106 can maintain a moving window to capture recurring patterns of close proximity. The moving window can be determined by the cycle time during which system 106 collects and analyzes the specified number of packets. System 106 can analyze packets within the window to determine if they match a signature of an attack type, or if they contain similar or matching data, thereby detecting an attack. The process of detecting an attack will be discussed below with reference to FIG. 6.

If an attack is detected in step 310, then the method can branch to step 320. In step 320, it can be determined whether the attack comprises a new attack type. In this regard, system 106 does not detect specific attacks. Rather, system 106 can detect and learn attack types, which will be discussed further below. If the attack comprises a new attack type, then the method can branch to step 325, where a signature of the new attack type can be learned by self-learning module 212. The method can then proceed to step 330, where countermeasure module 218 can initiate a defensive countermeasure. If step 320 determines that the attack comprises a known attack type, then the method can branch directly to step 330.

In step 335, system 106 can determine whether to initiate an offensive countermeasure against a source of the attack. If an offensive countermeasure is desired, then the method can branch to step 340 where a pathway for the offensive countermeasure can be provided before completion of the method. If step 335 determines that an offensive countermeasure is not desired, then the method can be complete without providing the pathway.

FIG. 4 is a flow chart depicting an initialization method according to an exemplary embodiment of the present invention, as referred to in step 305 of FIG. 3. In step 405, it can be determined whether to learn a signature of an attack type. If signatures have not been generated for a known attack type, then system 106 can learn the signature of the attack type. In that case, the method can branch to step 410 where the signature for the attack type can be generated. In step 415, the signature can then be stored in database 208. Then in step 420, it can be determined whether to generate a signature for an additional attack type. If an additional signature will be generated, then the method branches back to step 410. If an additional signature will not be generated, then the method can branch to step 425. If it is determined in step 405 that self-learning module 212 will not learn a signature of an attack type, then the method can branch directly to step 425.

In step 425, the load threshold for the host network can be set. The load threshold can represent a percentage of the network capacity beyond which a network attack can be indicated. A parameter “load threshold” can be configurable and can allow an operator to set the level of the network load that system 106 considers intolerable. Thus, the load threshold can be customized for any network to accommodate different connections such as telephone modem, cable modem, or DSL connections. The threshold can be established based on a percentage of bandwidth capacity of the network. In one exemplary embodiment, the threshold can be based upon a scale of 1 to 255. Thus, a load threshold of 80 percent would equate to a numeric value of 204 load threshold (255×0.80=204).

In step 430, the sleep time can be set. The parameter “sleep time” can be the duration of the sleep cycle in seconds. The sleep time represents the amount of time system 106 will pause at step 315 (FIG. 3) between cycles of packet analysis. A single cycle includes collecting and analyzing the specified number of packets and sleeping. If the sleep time is set to zero, then packet analysis can proceed on a continuous basis.

In step 435, the number of packets to be analyzed during each cycle can be set. The parameter ‘packet polled’ can set the number of packets to sample in each listening cycle. In step 440, packet sniffing module 210 can collect the specified number of packets for analysis. For example, the number of packets to be analyzed during each cycle can be set to twenty. During each cycle, packet sniffing module 210 can collect and analyze twenty packets and then system 106 can sleep the predetermined amount of time (assuming that system 106 did not detect an attack).

Each of the parameters discussed above can be established through a configuration screen of GUI 220, discussed below. After initialization is complete, the method can proceed to step 310 (FIG. 3).

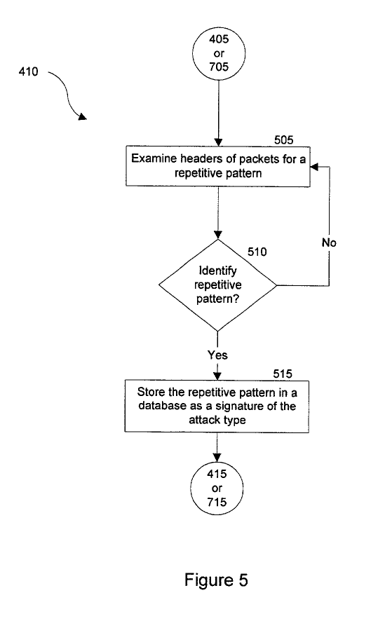

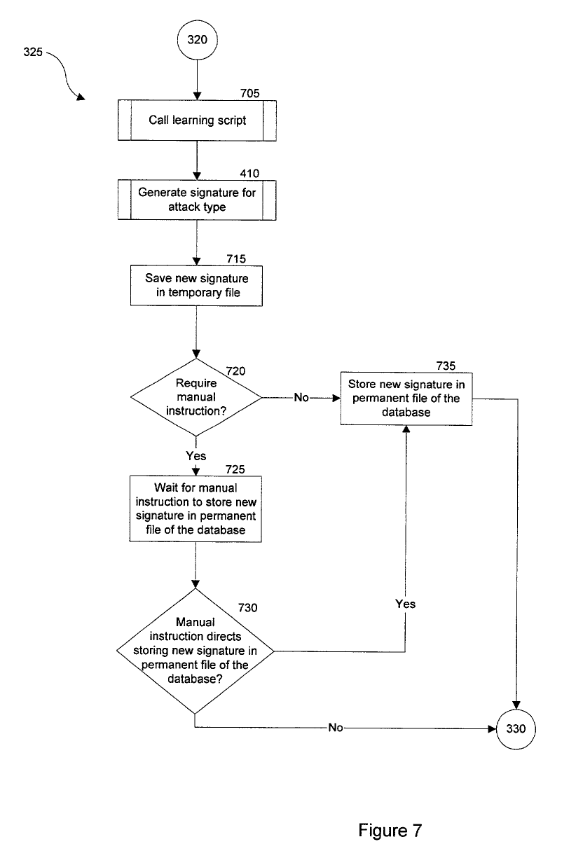

FIG. 5 is a flow chart depicting a method for generating a signature for an attack type according to an exemplary embodiment of the present invention, as referred to in step 410 of FIGS. 4 and 7. The exemplary method of FIG. 4 can generate an attack type signature for a flood-type DOS attack. Additionally, The exemplary method of FIG. 4 can generate an attack type signature for other network attack types such as an exploit attack.

Self learning module 212 can perform the method for generating a signature for an attack type. In step 505, self-learning module 212 can examine the entire contents, including headers, of data packets from the attack. In step 510, the examination can determine whether the packets include a repetitive pattern. If the packets include a repetitive pattern, then in step 515 self-learning module 212 can store the repetitive pattern in database 208. The repetitive pattern can represent the signature of the attack type. After the signature is stored in database 208, then the method can proceed to step 415 or 715 (FIG. 4 or 7, respectively), depending on the application. If the examination does not identify a repetitive pattern in step 510, then the method can branch back to step 505 to continue examining headers of packets from the attack.

An exemplary embodiment of the present invention can generate a signature for an attack type, rather than for a specific, known attack. Hundreds of specific, known attacks exist. Accordingly, comparing packets to hundreds of specific attacks can consume precious response time. On the other hand, exemplary system 106 can identify each of the hundreds of specific, known attacks by one of a limited number of attack types. The specific, known attacks contain characteristics that allow them to be grouped together and identified by their attack type. Thus, detection and response time can be significantly reduced because significantly fewer comparisons are required to detect an attack.

The characteristics for each attack type can comprise a set of data that is common to each specific attack within its attack type. Most flood attacks are merely a derivative of an earlier version of the attack. The original version and its derivative comprise the same attack type. Accordingly, most flood attacks have a common set of data that can identify a specific attack as associated with an attack type. The set of data can comprise the repetitive pattern identified in step 510 discussed above. In this regard, “repetitive” means that each attack within the attack type includes that set of data.

Thus, exemplary system 106 can detect attack types for DOS attacks that flood the victim system with a large number of often the same and sometimes similar packets. In the case of an attacker launching a new derivative of a known attack, conventional techniques cannot detect the new, specific attack. However, both the new attack the known attack from which it was derived correspond to the same attack type. Thus, exemplary system 106 can detect the new attack based on its attack type.

Only a relatively small number of attack types currently exist. The signatures for the attack types according to an exemplary embodiment of the present invention can be related to protocols. Only three protocols are currently used for transmitting information over the Internet. Those protocols are TCP, UDP, and ICMP. Accordingly, at least three attack types exist for a typical flood attack using each protocol. However, exemplary system 106 has currently generated seven attack types that can identify hundreds of specific, known attacks. Additionally, exemplary system 106 can learn a new attack type and can store the new attack type for future use.

The following example illustrates how an exemplary embodiment can use a signature for an attack type to determine if packets are part of a flood attack. In a TFN/TCP flood attack, the signature can be the following:

S*:*(16) win 65535 urg 50200

Where ‘*’ stands for a sequence of digits, or specifically, a sequence number. Thus, the signature can allow the exemplary embodiment to match a partial pattern to the signature, regardless of the contents of the pair of sequence numbers.

FIG. 6 is a flow chart depicting a method for detecting a network attack according to an exemplary embodiment of the present invention, as referred to in step 310 of FIG. 3. Due to the nature of a DOS/DDOS attack, offending packets may trickle in slowly in the beginning of the attack. The packets can enter the system through a number of compromised machines on unrelated networks. In other words, detection and confirmation of a DOS/DDOS attack in the early stage can be difficult. However, the exemplary method illustrated in FIG. 6 can be implemented to be slightly aggressive and can detect an attack even in its initial stages.

In step 605, packet sniffing module 210 can read each packet collected during a cycle and can compare information in each packet to a signature stored in database 208. Packet sniffing module 210 can compare all information in each packet, or a portion of the information in each packet, to a signature stored in database 208. In step 610, it can be determined whether the information from a packet matches a signature in database 208. If the information from a packet matches a signature in database 208, then packet sniffing module 210 has detected an attack, and the method can branch to step 615. If step 610 determines that information from a packet does not match a signature in database 208, then the method can branch to step 620.

Instead of only listening for known DOS/DDOS patterns based on their attack type, the detection method of FIG. 6 can signal an alert upon identifying similar patterns in the incoming packets. On a normal network, it is very rare for two packets having similar or matching information to occur in succession or in close proximity. Additionally, the probability of an attack increases with each additional packet in close proximity having similar or matching information. Accordingly, exemplary system 106 can detect an attack based on any two packets in close proximity having similar or matching information. Close proximity can be defined by the specified number of packets collected and examined during a cycle. Thus, exemplary system 106 can provide a moving window in which the specified number of packets can be analyzed with respect to each other to detect a flood attack.

Accordingly, in step 620, the packets can be compared to each other. Packet sniffing module 210 can compare all information in each packet, or a portion of the information in each packet, to the information in other packets. In step 625, packet sniffing module 210 can determine whether the packets include similar or matching data. In this regard, similar or matching data can include two packets having the same header except for a sequence number, having similar payload information with o different headers, or having portions of a header or payload information that are the same. If the packets include similar or matching data, then packet sniffing module 210 has detected an attack, and the method can then branch to step 615.

For added reliability, the detection routine can be complemented by verification that the network traffic is unusually high before triggering an “Alert” message and/or countermeasure. Thus, in step 615, it can be determined whether decision module 206 will confirm the attack. If decision module 206 will not confirm the attack, then the method can branch directly to step 645 where an indication of the attack can be provided on GUI 220. From step 645, the method can proceed to step 320 (FIG. 3). If step 615 determines that decision module 206 will confirm the attack, then the method can branch to step 630. Additionally, if packet sniffing module 210 does not detect an attack in step 625 by determining that the packets include similar or matching data, then the method can also branch to step 630 for an alternative method of detecting the attack. In step 630, router daemon module 216 can interface with host router 104 to determine the current network load. Router daemon module 216 can then provide that information to decision module 206.

In step 635, decision module 206 can compare the current network load to the load threshold. The load threshold has been previously established in step 425 of the initialization phase (FIG. 4). In step 640, decision module 206 can determine whether the current network load exceeds the set load threshold. If the current load does not exceed the threshold, then decision module 206 has not confirmed that attack (or alternatively has not detected an attack). If the attack is not confirmed, then the event can be recorded as a warning, and the method can branch to step 315 to sleep until the beginning of the next cycle (FIG. 3). Thus, using the load threshold to confirm an attack can provide a backup measure to ensure that the system does not deploy a countermeasure against normal system traffic.

If step 640 determines that the current load exceeds the threshold, then decision module 206 has confirmed or detected the attack. Accordingly, the method can branch to step 645, where the attack can be indicated on GUI 220. The method can then proceed to step 320 (FIG. 3).

Accordingly, the confirmation method described above can validate the attack to determine whether or not to deploy a countermeasure before the communication lines become saturated due to the increase of incoming data packets. If system 106 determines that the network is under a DOS/DDOS attack, then the appropriate countermeasure can be immediately deployed. If system 106 determines that the incoming packet data falls within normal traffic parameters, then it can return to sleep mode and wait until it's next packet sniffing cycle.

Thus, exemplary system 106 can provide an automated tool designed to monitor system traffic. The system loops around during two steps: listening and sleeping. During the listening cycle, system 106 can observe a configurable number of packets, watching for suspicious data. After identifying a suspicious pattern, system 106 can query host router 104 for network load information. If the load is within the configurable, load threshold, then system 106 can log the incident as a “Warning.” On the other hand, if the network load reaches the set threshold, then system 106 can launch a countermeasure routine and can log the time of the flood, the time of the countermeasure deployment, and the source and destination of the offending packet(s).

FIG. 7 is a flow chart depicting a method for learning a signature of a new attack type according to an exemplary embodiment of the present invention, as referred to in step 325 of FIG. 3. In step 705, self-learning module 212 can execute a learning script. The method can then proceed to step 410, where a signature for the new attack type can be generated. The method for generating a signature for a new attack type has previously been discussed above with reference to FIG. 4. In step 715, the new signature can be saved in a temporary file of database 208. Then, in step 720, it can be determined whether a manual instruction is required before storing the new signature in a permanent file of database 208. If a manual instruction is not required, then the method can branch directly to step 735, where the new signature can be stored in a permanent file of database 208. The method can then proceed to step 330 (FIG. 3). If step 720 determines that a manual instruction is required, then the method can branch to step 725. In step 725, the method can wait for a manual instruction. After receiving the manual instruction, self-learning module 212 can determine in step 730 whether the manual instruction directs storing the new signature in a permanent file of database 208. If yes, then the method branches to step 735, discussed above. If the manual instruction does not direct storing the new signature in a permanent file of database 208, then the method completes by branching to step 330 (FIG. 3).

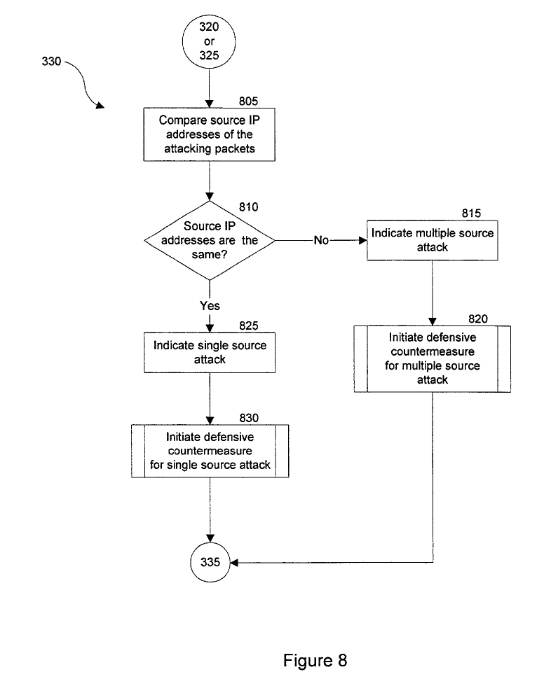

FIG. 8 is a flow chart depicting a method for initiating a defensive countermeasure according to an exemplary embodiment of the present invention, as referred to in step 330 of FIG. 3. In step 805, trace route module 214 can compare the source IP addresses of the attacking packets. In step 810, trace route module 214 can determine whether the source IP addresses are the same. If the source IP addresses are the same, then a single source produced the attack. Accordingly, the method can branch to step 825, where trace route module 214 can provide an indication of a single source attack on GUI 220. The method then proceeds to step 830, where countermeasure module 218 can initiate a defensive countermeasure for the single source attack. The method then completes by proceeding to step 335 (FIG. 3).

If trace route module 214 determines in step 810 that the source IP addresses of the attacking packets are not the same, then multiple sources produced the attack. Accordingly, the method can branch to step 815, where trace route module 214 can provide an indication of the multiple source attack on GUI 220. The method can then proceed to step 820, where countermeasure module 218 can initiate a defensive countermeasure for the multiple source attack. The method then completes by proceeding to step 335 (FIG. 3).

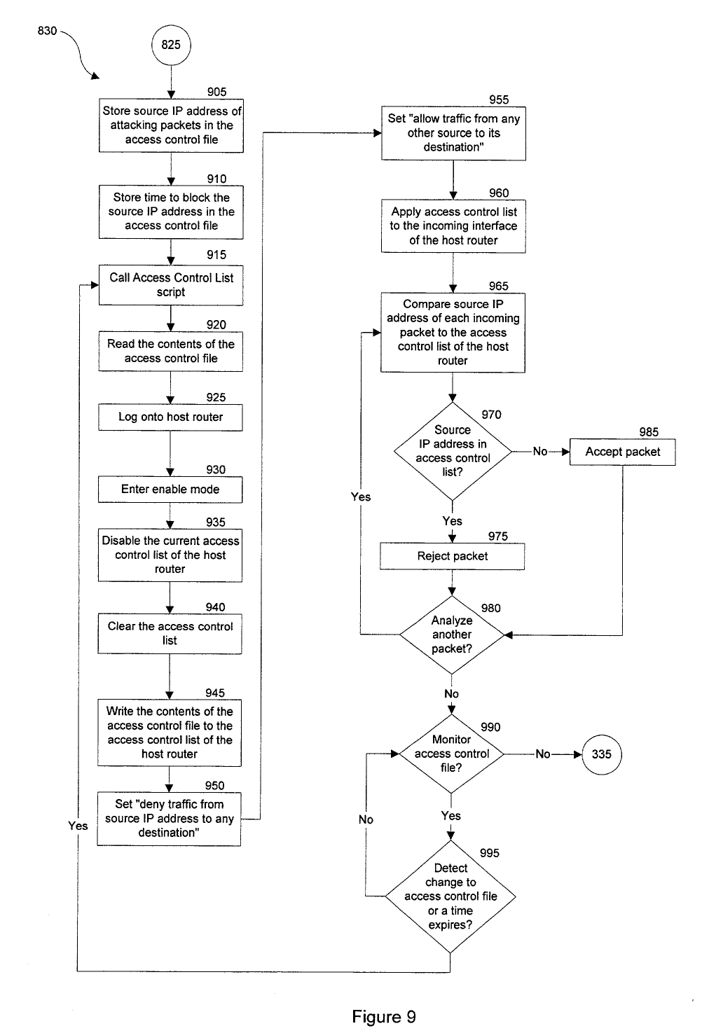

FIG. 9 is a flow chart depicting a method for initiating a defensive countermeasure for a single source attack according to an exemplary embodiment of the present invention, as referred to in step 830 of FIG. 8. Router daemon module 216 can execute the steps illustrated in FIG. 9 to initiate the single source countermeasure. In step 905, router daemon module 216 can store the source IP address of the attacking packets in an access control file. In step 910, router daemon module 216 can also store in the access control file a time to block the source IP address.

In step 915, an access control list script can be executed to implement the single source countermeasure at host router 104. In step 920, the contents of the access control file can be read. Router daemon module 216 can then log onto host router 104 in step 925. In step 930, enable mode can be activated to allow changes to an access control list of host router 104. In step 935, the access control list script can disable the current access control list of host router 104. Then in step 940, the access control list of host router 104 can be cleared. The contents of the access control file can then be written to the access control list of host router 104 in step 945.

The host router can then be configured to deny or allow certain traffic destined for host network 101. In step 950, the access control list script can set host router 104 to “deny traffic from the source IP address to any destination.” Then in step 955, the access control list script can set host router 104 to “allow traffic from any other source to its destination.” In step 960, the access control list can be applied to the incoming interface of host router 104. At this point, the initiation of the single source countermeasure is complete. The following steps describe the operation of host router 104 to protect host network 101 from attack based on the single source countermeasure.

In step 965, host router 104 can compare the source IP address of each incoming packet to the access control list. Accordingly, host router 104 can determine in step 970 whether the access control list includes the source IP address. If the access control list includes the source IP address, then the packet can be rejected in step 975. The method can then proceed to step 980, where host router 104 can determine whether additional packets remain to be analyzed. If host router 104 determines in step 970 that the access control list does not include the source IP address, then the packet can be accepted in step 985 before proceeding to step 980. Accordingly, the exemplary method only rejects packets having the attacking source IP address. The countermeasure does not affect packets having another source IP address.

If additional packets remain to be analyzed in step 980, then the method can branch back to step 965 to continue processing the incoming packets. If additional packets do not remain, then the method can branch to step 990. In step 990, router daemon module 216 can monitor the access control file. In step 985, router daemon module 216 can determine whether a new source IP address has been added to the access control file, or whether a block time has expired for a source IP address listed in the access control file. If the method detects such a change to the access control file, the method can branch back to step 915 to update the access control list of host router 104. If step 985 does not detect such a change, then the method can branch back to step 990 to continue monitoring the access control file. If router daemon module 216 will not monitor the access control file in step 990, then the method can proceed to step 335 (FIG. 3).

Thus, the exemplary method can provide “one-click” implementation of the access control file to host router 104. That “one-click” implementation can update the host router 104 to deny traffic having the attacking source IP address. Router daemon module 216 can comprise a program used by the A.N.T. server to interface with host router 104. Router daemon module 216 essentially can create a telnet session for the A.N.T. server and can execute router scripts (a series of commands for the router operating system) that perform specific functions. Router daemon module 216 also can import external variables from other information sources. Whether passed to router daemon module 216 via the command line, or stored in a config file, router daemon module 216 can import the data and can use it in conjunction with the router scripts. Accordingly, a single script can be executed each time a new attacking IP address or target IP address is identified, and router daemon module 216 can import that IP address to be used within the script.

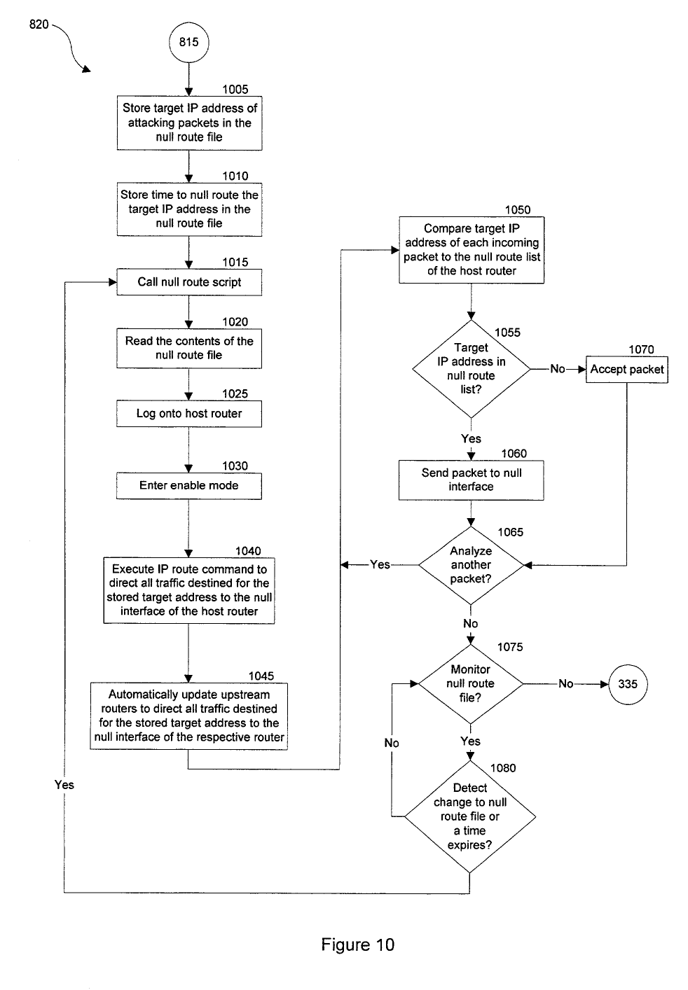

FIG. 10 is a flow chart depicting a method for initiating a defensive countermeasure for a multiple source attack according to an exemplary embodiment of the present invention, as referred to in step 820 of FIG. 8. In step 1005, router daemon module 216 can store the target IP address of the attacking packets in a null route file. Additionally, router daemon module 216 can store in the null route file a time to null route the target IP address. Then in step 1015, router daemon module 216 can execute a null route script to implement the multiple source countermeasure at host router 104. Then in step 1020, the contents of the null route file can be read.

Router daemon module 216 can log onto host router 104 in step 1025, and it can enter the enable mode in step 1030 to allow changes to host router 104. In step 1040, the contents of the null route file can be written to a null route list of host router 104 by executing an IP route command to direct all traffic destined for the stored target address to the null interface of host router 104. In step 1045, upstream routers can be automatically updated to direct all traffic destined for the stored target address to the null interface of their respective router. The upstream routers can be automatically updated by the closest downstream router. In other words, host router 104 can automatically update uplink router 110. Uplink router 110 can then automatically update the next upstream router. Depending on the routing protocol, a minimum of sixteen upstream routers can be automatically updated to null route packets having the target IP address. Accordingly, the countermeasure can stop the attacking packets upstream of host network 101, thereby limiting or preventing the attacking packets from traveling on the Internet.

At this point, the implementation of the multiple source countermeasure is complete. The following steps describe the operation of host router 104 and upstream routers to direct all traffic destined for the stored target address to a null interface. Steps 1050-1070 will be described with reference to host router 104. However, steps 1050-1070 can be performed by any upstream router to prevent further transmission of the attacking packets. In step 1050, host router 104 can compare the target IP address of each incoming packet to the null route list. In step 1055, host router 104 can determine whether the null route list includes the target IP address. If the null route list includes the target IP address, then host router 104 can reject the incoming packet in step 1060 by sending the incoming packet to its null interface. The method can then proceed to step 1065, where it can determine whether additional packets remain to be analyzed. If additional packets remain, the method can branch back to step 1050 to continue analyzing incoming packets. If step 1055 determines that the null route list does not contain the target IP address, then host router 104 can accept the packet in step 1070 before continuing to step 1065, discussed above.

If step 1065 determines that additional packets do not remain to be analyzed, then the method can branch to step 1075. In step 1075, router daemon module 216 can monitor the null route file. In step 1080, router daemon module 216 can determine whether a new target IP address has been added to the null route file or whether a block time has expired for a target IP address existing in the null route file. If router daemon module 216 detects such a change, then the method can branch back to step 1015 to update the null route list of host router 104. If router daemon module 216 does not detect such a change in step 1080, then the method can branch back to step 1075 to continue monitoring the null route file. If router daemon module 216 will not monitor the null route file in step 1075, then the method can proceed to step 335 (FIG. 3).

Accordingly, the exemplary method can provide “one-click” implementation of the null route file on host router 104. That “one-click” implementation can update the host router 104 to null route traffic destined for the target IP address. Router daemon module 216 can implement the multiple source countermeasure similarly to the implementation of the single source countermeasure, as discussed above.

FIGS. 8-10 describe exemplary embodiments of the present invention for deploying a defensive countermeasure. Each can involve modifications to firewall rules or the routing table. If the offending packets come from a single source IP address (real or spoofed), then exemplary system 106 can block the attacking packets through the Internet connection at host router 104 by denying that particular IP address service by host router 104. In other words, host router 104 will not route any packets coming from the attacking IP address.

On the other hand, if the offending packets come from multiple sources using real or spoofed source IP addresses, exemplary system 106 can deploy a more extreme countermeasure. In that case, exemplary system 106 can send out multiple countermeasures to the uplink routers to block all packet traffic to the target IP address at uplink router 110 and preceding routers. Accordingly, exemplary system 106 can temporarily fool the attacker to believe that the victim's IP address has been flooded.

Furthermore, exemplary system 106 can proceed to stop all outbound traffic, if any, to the source of the attack and to deny all inbound traffic from the attacking IP address(s). As the countermeasure time duration expires for each attack, the system 106 can resume routing packets to the victim IP address and can reactivate countermeasures if hostile packets still exist.

The present invention is not limited to the exemplary countermeasures described above, and other countermeasures for defending against a flood-type DOS attack are within the scope of the present invention.

Router daemon module 216 can perform portions of the methods depicted in FIGS. 8-10 while system 106 performs other portions of method 300. Additionally, multiple A.N.T. servers can be provided for multiple host routers. A central monitoring station can provide command and control of the multiple A.N.T. servers deployed throughout the host system. If one A.N.T. server detects an attack, it can communicate to the other A.N.T. servers and the countermeasure can be implemented at each host router by its corresponding A.N.T. server. Additionally, if one A.N.T. server learns a new signature, it can communicate the signature to other A.N.T. servers for future use in detecting that attack type.

The countermeasure methods discussed above can be implemented as script files with a acl or null extension. The scripts can accomplish the tasks of modifying firewall rules to deny service to the attacking IP address or addresses and to null route packets with the target IP address. If the flooding is of the single-source type, no packets will be routed from that source to the victim IP address for the specified block time. If the flooding is of the multiple-source type, no packets will be routed to the victim IP address for a specified block time. The block time can be specified by the parameter “bkholedu” (black hole duration), which can be the duration of the block time period measured in minutes. That parameter can be established using the configuration screen of GUI 220, discussed below. The block time period can determine how long to block an IP address before system 106 allows it back on the network. That rule of modification can effectively render the victim computer unreachable from the Internet. As a result of launching either script, a log history can appear in “log.txt” (log text) in GUI 220 and can indicate deployment of the appropriate countermeasure.

Exemplary embodiments of a Graphical User Interface (GUI) for allowing a user to interact with the A.N.T. system 106 will be described below. The exemplary GUI can be implemented by accessing an A.N.T. system 106 over the Internet using an Internet browser. Alternatively, the GUI can be implemented with a central monitoring station (CMS) that can monitor one or more anti-network terrorism systems.

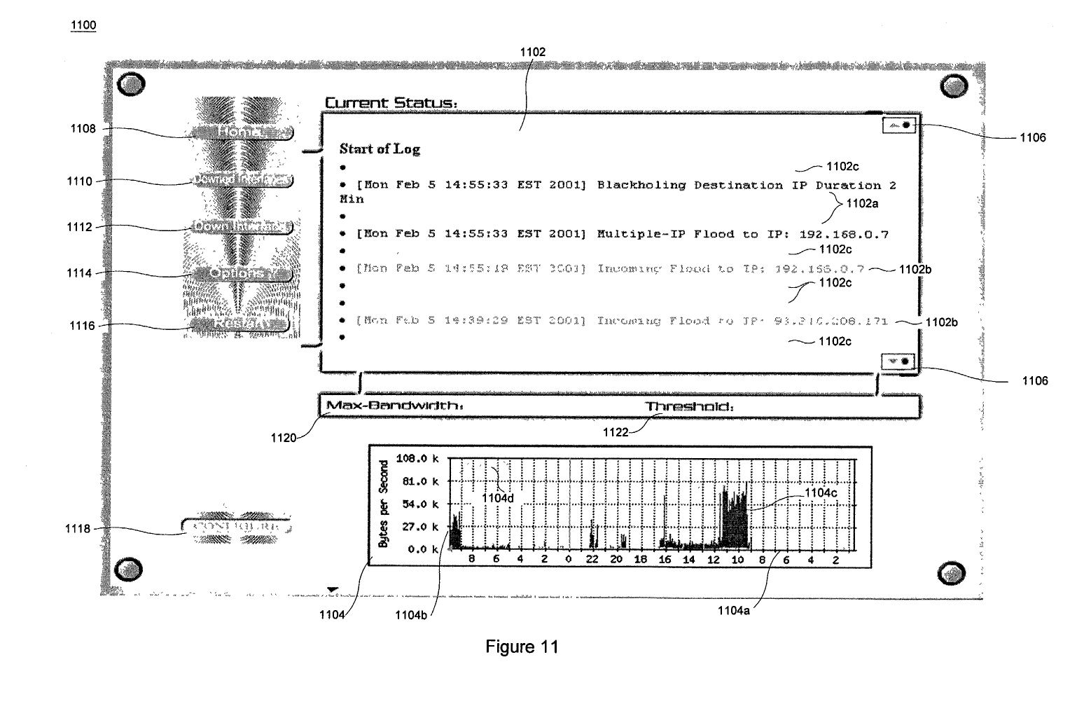

With reference to FIGS. 11-16B, a GUI implemented by accessing an anti-network terrorism system over the Internet using an Internet browser will be described. The GUI can be color coded to provide easy identification of the types of entry. The actual colors used to represent a particular entry type are not critical to the operation of the system 106. Exemplary color coding schemes are discussed below.

FIG. 11 illustrates an exemplary main page GUI 1100 for overall operations of the A.N.T. system 106. A Network administrator can configure, control, and monitor all functionality of an A.N.T. system from main page 1100. From this single screen display, main page 1100 can provide up to the minute, color coded reports for viewing all incoming or outgoing launched DOS/DDOS attacks.

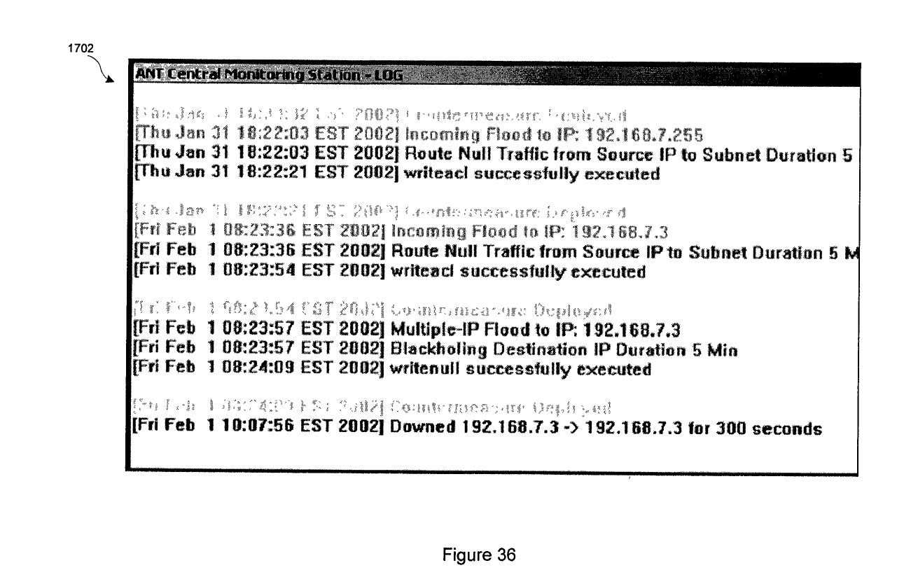

A log history block 1102 can include easy to read log entries of events for the system. For example, a log history 1102a can be identified in gray and can provide the time, day, month, and IP address under attack. Once the system has identified a flood attack, a log history 1102b can be made in red. A log history 1102c can be colored blue and can depict the time, day, and month that the system deployed a countermeasure against the attacking source. Manually added changes to the router (not shown) can be highlighted in yellow. Potential warnings of abnormal traffic flow (not shown) can be illustrated in black. Log history block 1102 can be refreshed in one-minute intervals to reflect new data or information added to main page 1102. For a larger view of an exemplary log history block 1102, see FIG. 36.

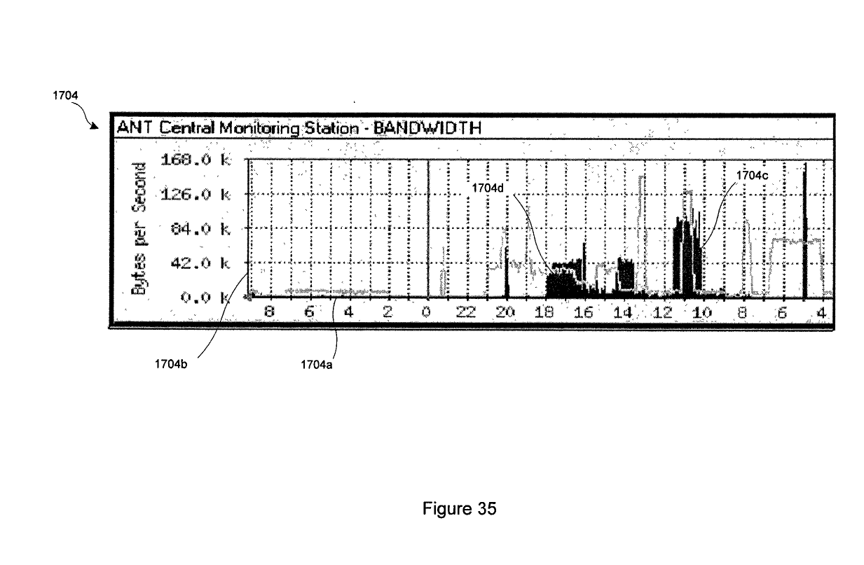

A network bandwidth utilization chart 1104 can show in real time incoming and outgoing network traffic on a minute-by-minute basis. Chart 1104 can comprise a thirty hour time frame 1104a displayed across its x axis and traffic levels or “Bits/Bytes/Mbytes per Second” 1104b can displayed on its y axis. Chart 1104 can illustrate an inbound bandwidth utilization 1104c and outbound traffic 1104d. Chart 1104 can be constantly updated on a per minute basis. The time graph can be read from left to right, showing spikes in bandwidth utilization with the left edge depicting current network traffic. The traffic flows can also be color coded. For example, inbound bandwidth utilization 1104c can be illustrated in green, and outbound traffic 1104d can be illustrated in blue. For a larger view of an exemplary bandwidth utilization chart 1104, see FIG. 35.

Two control buttons 1106 can provide for scrolling up and down log history block 1102. Additionally, interface, or function, buttons 1108-1118 can provide access to other GUI screens discussed below. Function buttons 1108-1118 can be provided on each GUI screen, thereby allowing all functionality of the system to be accessed from each related GUI interface display. Home function button 1108 calls main page 1100, discussed above. Each of function buttons 1110-1118 can call a separate interface screen, as discussed below. Finally, a max-bandwidth block 1120 can provide the maximum bandwidth noted within the thirty hour window illustrated in chart 1104. A threshold block 1122 can provide the specified load threshold set on the configuration screen discussed below.

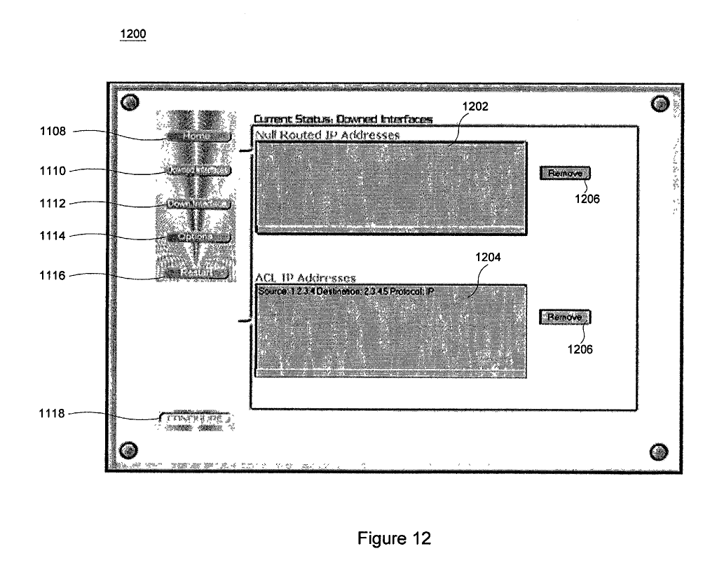

FIG. 12 illustrates an exemplary downed interfaces screen 1200 referenced by function button 1110. Downed interfaces screen 1200 can provide the ability to display the network IP addresses that are not currently accessible to the Internet by the host system. A null route block 1202 can list all null routed IP addresses. Addresses listed in null route block 1202 are on the protected host network. However, traffic cannot be currently routed to them when they are in a “Downed Interface” table. Any packets directed towards these downed addresses will be promptly discarded by being directed to a null interface. In the case of a multi-sourced flood, the A.N.T. system will null route the target address for a pre-determined period of time. Thus, the malicious packets destined to a listed IP address do not slow down or stop legitimate traffic from reaching the host network.

An access control list block 1204 can list IP addresses for stopping data from a single source attack location. When malicious packets come into the network from a particular source location, the system can block all traffic from that source at the router level.

Remove buttons 1206 can allow a system administrator manually to reverse the status of any downed IP address. Highlighting the entry and then pressing the “Remove” button will remove a downed IP address. Additionally, blocks 1202 and 1204 can display the block time (not shown) remaining for any listed downed IP address. That “Time Remaining” feature can be set accessing a configure screen by selecting the “Configure” button 1118, discussed below. The block time can be variable from 1 to 65,535 minutes.

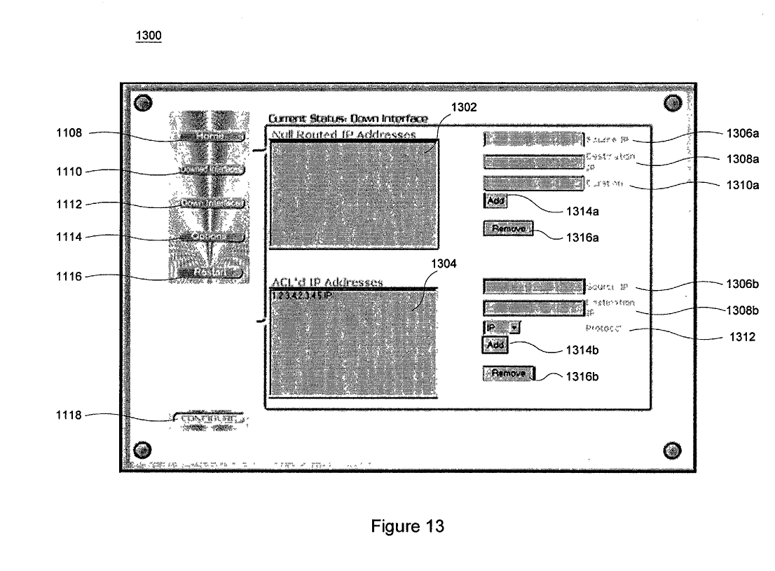

FIG. 13 illustrates an exemplary down interface screen 1300 referenced by function button 1112. Screen 1300 can allow a system administrator to enter manually a “Source” and “Destination” IP address, along with a time duration to take down a network interface. That manual selection process can allow blocking of certain types of data to a network segment or taking an interface down at the router level. Screen 1300 can allow a simple solution to a difficult process in which the router will block traffic to and from a designated IP address at the discretion of the systems administrator. As in FIG. 12, a null route block 1302 can be dedicated to null routed IP addresses, while an access control list (ACL) block 1304 can list a programmed database of access control lists set-up by the systems administrator.

To place an IP address in null route block or 1302 or ACL block 1304, the administrator performs the following steps. The source IP address can be entered into block 1306a or 1306b for null route block 1302 or ACL block 1304, respectively. The destination IP address can be listed in block 1308a or 1308b. A block time for null routing the data can be entered in block 1310a. A similar block time (not shown) can be entered for access control listing the data. Then, the address can be added to block 1302 or 1304 by selecting an add button 1314a or 1314b, respectively. Additionally, items can be removed from blocks 1302 or 1304 by highlighting the item and then selecting a remove button 1316a or 1316b, respectively. For items in ACL block 1304, the protocol can be selected by accessing protocol block 1312.

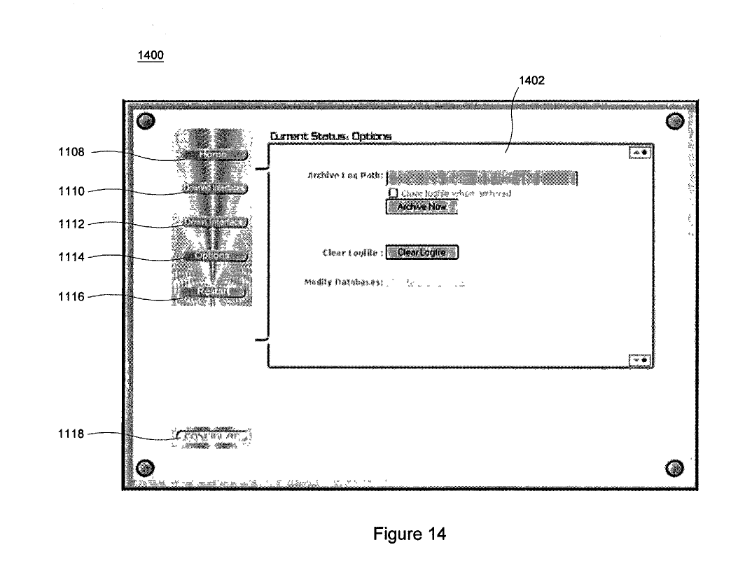

FIG. 14 illustrates an exemplary options screen 1400 referenced by function button 1114. Options screen 1400 can be an added non-restricted feature that can provide flexibility to the A.N.T. system by allowing the user to add or delete functions or program routines. An option block 1402 can provide the ability to archive and store log files. Those stored logs can provide packet information that can be used for forensic analysis to determine unique characteristic of captured data packets. Additional options can be reserved for insertion into this screen. For restricted options, the user can use the configure screen discussed below.

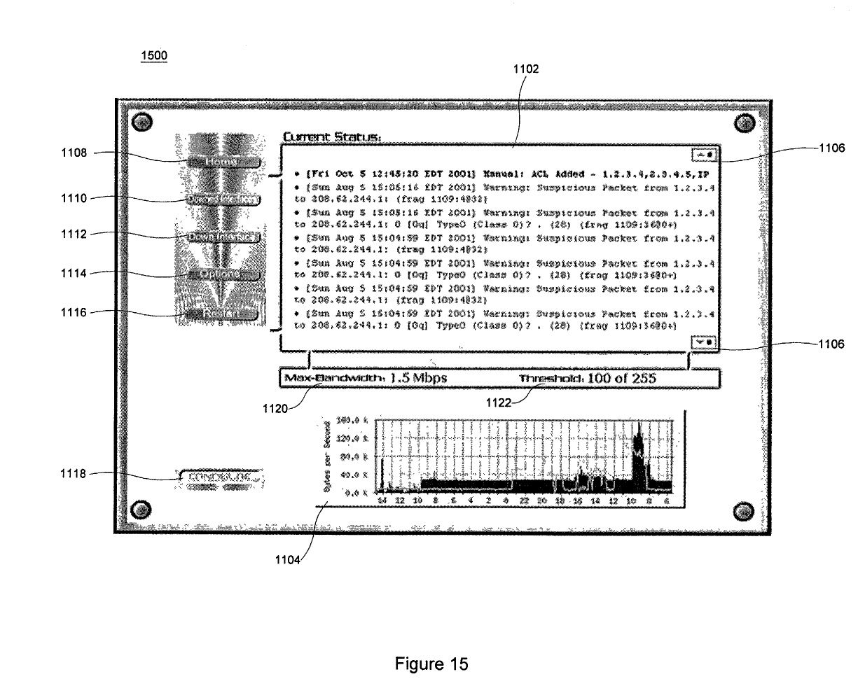

FIG. 15 illustrates an exemplary restart screen 1500 referenced by restart button 1116. Restart button 1116 can provide the ability to reload or refresh all the variables set in the configuration screen on the fly without affecting system operation. Restart button 1116 can allow the system to reconfigure its sleep time mode without having to take the system off line when configured for full time system monitoring. Accordingly, restart screen 1500 can provide a refreshed version of main screen 1100 discussed above. Under normal circumstances, the system will reload the configuration data at the start of each active cycle. This time frame can be set under the configuration screen itself, discussed below.

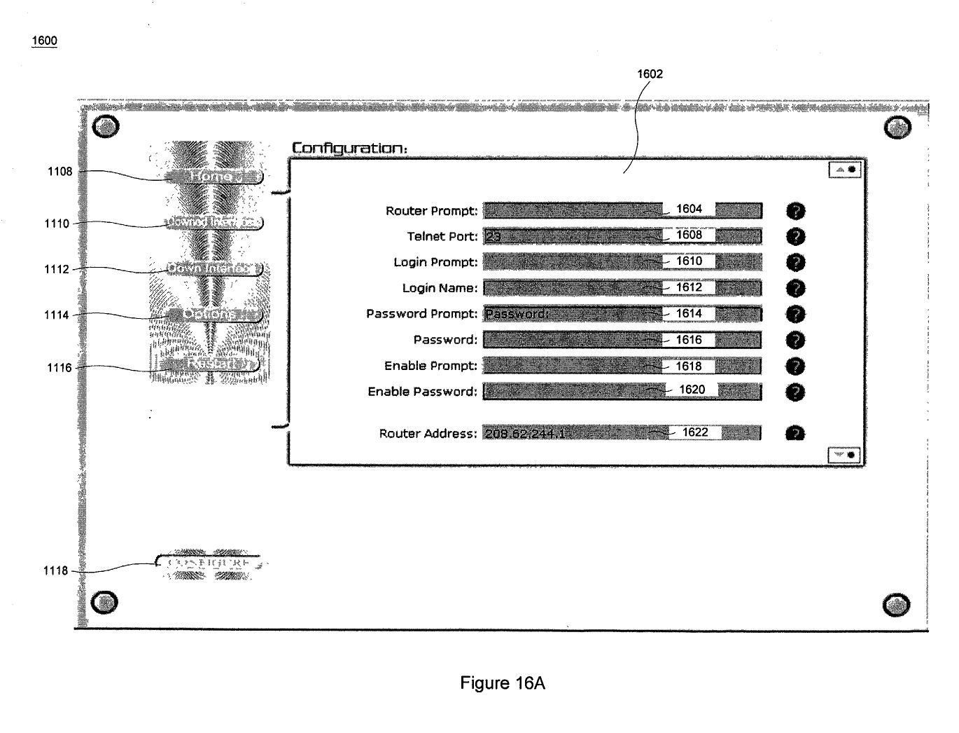

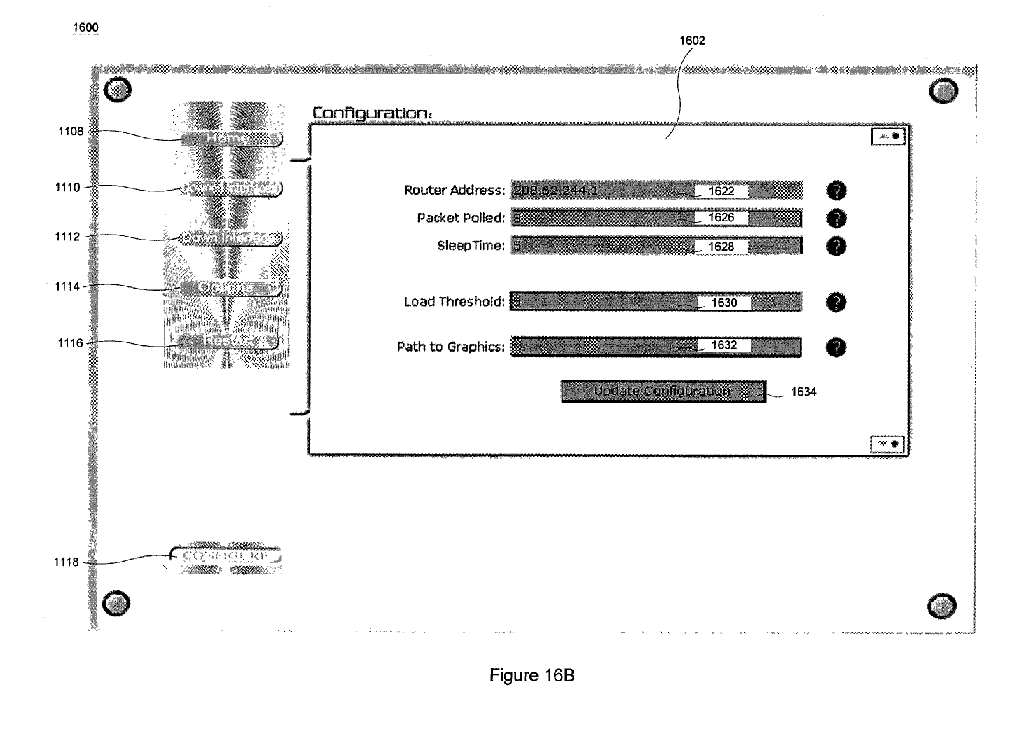

FIGS. 16A and 16B illustrate an exemplary configuration screen 1600 referenced by configure button 1118. Configure button 1118 can be the link to the main configuration (setup) screen 1600 for configuring the A.N.T. system. All system variables, as well as passwords, can be entered and stored through screen 1600. Screen 1600 can be password protected, and the network administrator can restrict access to it. Through screen 1600, an administrator can set all the configured variables that the system needs to communicate with a host network router, can establish active and sleep modes, and can establish the settings for the host router line load thresholds.

All passwords on this page can be encrypted for security purposes but can be changed from the web-based interface. Because the system can use a graph generated by Multi-Router Traffic Grapher (MRTG), the path to the graphic file can be also entered from this screen in block 1632. MRTG can allow the system the ability to show real-time traffic statistics, without directly logging in to the host router. The variables can allow the system to interact with other network components in the shortest possible time. A “Router Prompt” block 1604 can allow the system to communicate with the host router to execute commands automatically.

For example, the router name can be “core.” The prompt can be entered in the Router Prompt block 1604 as “core>.” A “Telnet Port” block 1608 can allow specification of a port on the host router that can be used to establish communications with the A.N.T. system. Normally, that port is port 23, which can be the standard telnet port for any operating system. A “Login Prompt” block 1610 can allow entry of the first router prompt after the communication link is established by the Telnet link to the host router.

The example below can be a common entry for communicating to a Cisco router:

Trying 208.62.244.1 . . .

Connected to core-gwl.cyops.net.

Escape character can be ‘ˆ ]’.

User Access Verification

Password: ______

A “Login Name” block 1612 can allow entry of the username for logging onto the router. On most routers, a “Login Name” may not be necessary to gain router access. Typically, only the router password is needed. In that case, the login name can be left blank. A “Password Prompt” block 1614 can allow entry of a normal prompt that the router gives a user when requesting a password. Normally, that prompt would be the word “Password.” The password can be established in block 1616.

An “Enable Prompt” block 1618 can allow entry of an enable prompt given when a user enters the enable mode of the router. The enable mode can allow high-level commands to be executed in the router. In most cases, the enable prompt can be the router prompt, followed by a pound sign (#), rather than the greater than sign (>). An “Enable Password” block 1620 can allow entry of a selectable password that can allow the user to enter high-level router commands. The password can be stored in an encrypted string on the A.N.T. system and may not be displayed in plain text.

A “Router Address” block 1622 can allow entry of the IP address at which the router resides. That IP address can be utilized by the system to telnet to the router to gain access. A “Packets Polled” block 1626 can allow entry of the number of packets that the system will collect and analyze during any given listening cycle. Once the system has collected the specified number of packets, it will begin to analyze them as discussed above. A “Sleep Time” block 1628 can allow entry of the duration of the sleeping cycle. The sleeping cycle can be varied by entering a specified time. A “Load Threshold” block 1630 can allow entry of a set level beyond which the system will detect or confirm a network flood attack.

A “Path to Graphics” block 1632 can allow entry of a default directory for the MRTG charts stored on the A.N.T. system, thereby enabling the “Main Page” to display the current log status and the system bandwidth chart in real time. An “Update Configuration” button 1634 can allow new configuration data to be written to a “config” file.

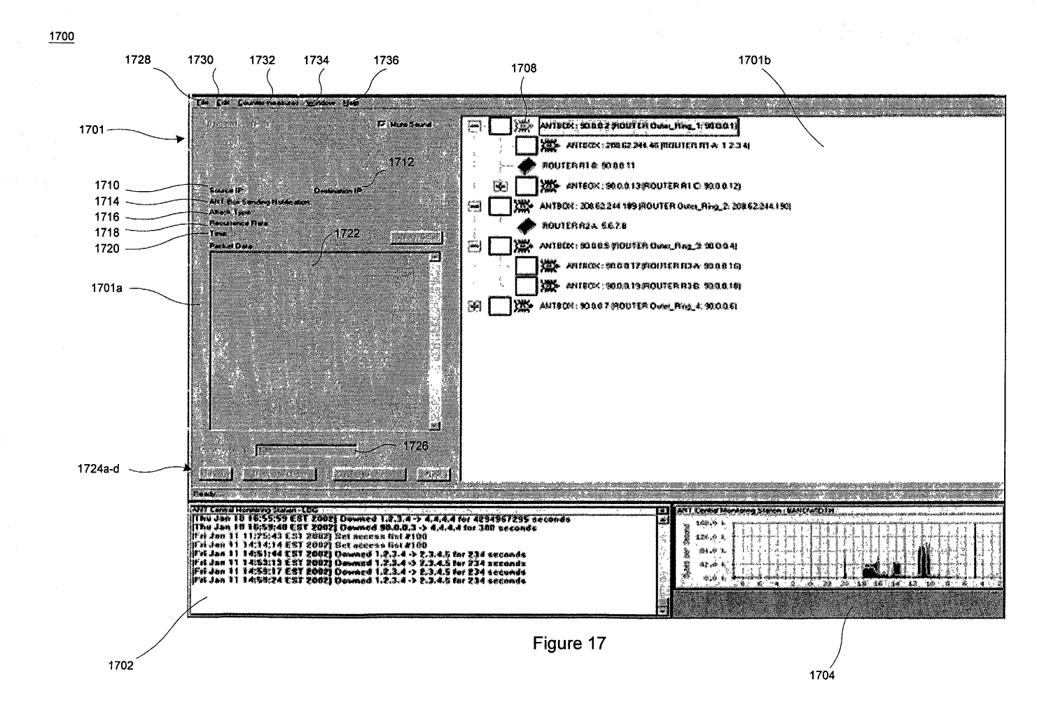

When more than one A.N.T. system is provided on a host network, a central monitoring station” (CMS) can be provided for monitoring each system within the network. The CMS can provide central command and control of A.N.T. systems on a distributed network A GUI for a CMS will now be described. FIG. 17 illustrates an exemplary main screen GUI 1700 for a CMS. Main screen 1700 can comprise three individual screens. The top screen can comprise an A.N.T. Central Monitoring Station (ACMS) screen 1701 of the windows command system, which can provide management and control over all deployed A.N.T. servers and routers. The number of A.N.T. servers and routers can be shown in a tree configuration view 1701b on the right side of ACMS screen 1701. Within this tree configuration can be a small icon 1708 for each A.N.T. server within the network. Icon 1708 can be color coded to indicate a status of the respective A.N.T. server. For example, a green icon 1708 can indicate normal operation, or a red icon 1708 can indicate an attack.

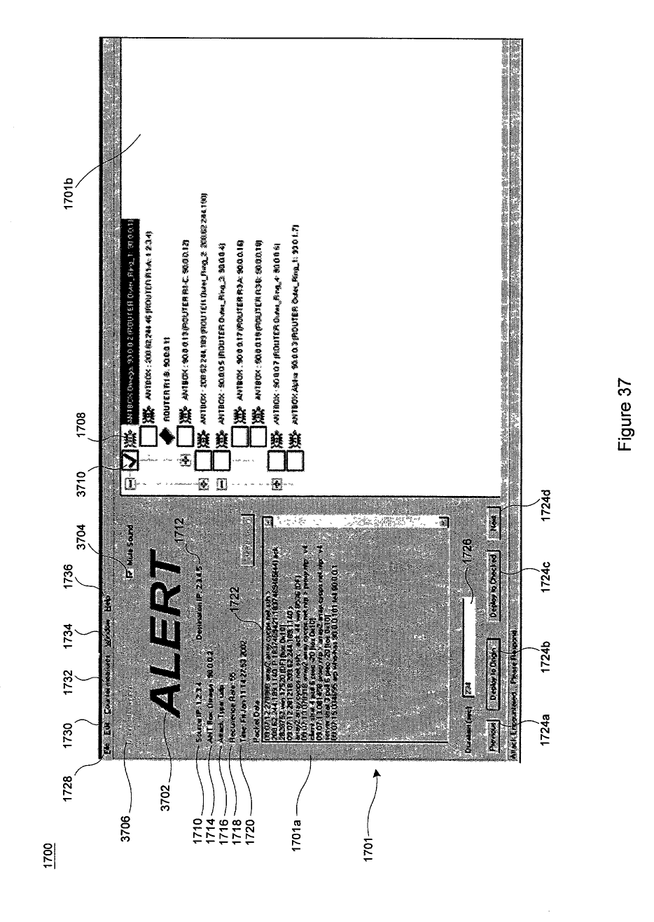

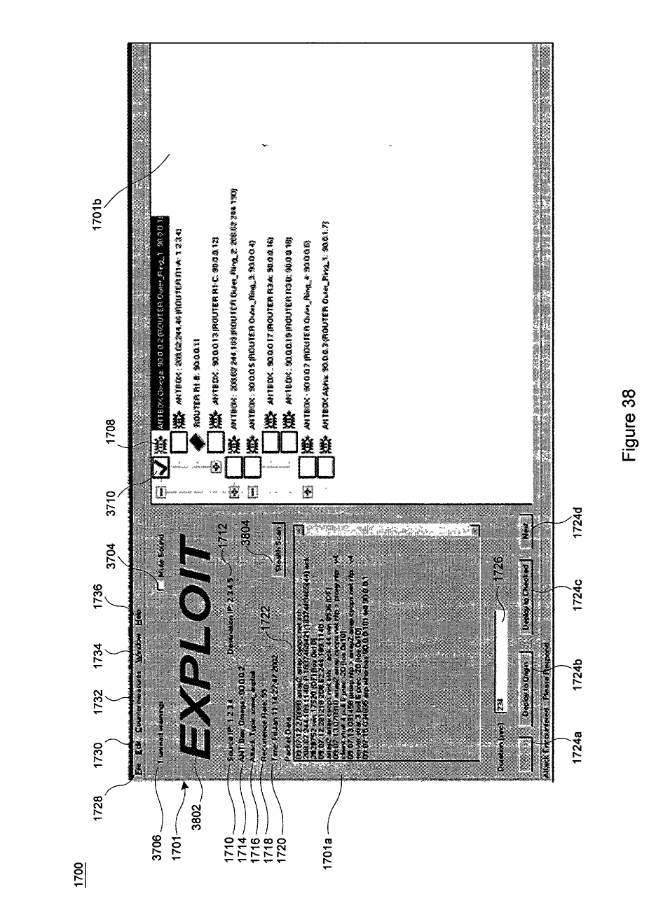

The left side 1701a of ACMS screen 1701 can display any warning messages and pertinent information relating to the message. The information can be displayed in the following blocks, which indicate the type of information contained therein: Source IP address block 1710, Destination IP address block 1712, the ANT Box Sending the Notification block 1714, Attack Type block 1716, Recurrence Rate block 1718, Time block 1720, and Packet Data window 1722. Below the Packet Data window 1722 can be additional buttons 1724a-d for functional management and countermeasure deployment. Buttons 1724a-d are discussed below with reference to FIGS. 37 and 38. A text block “Duration (sec)” 1726 can allow an operator to override the default time duration that an IP will be blocked from the host network.

ACMS screen 1701 can also include menu buttons 1728-1736 for accessing other windows based screens for the CMS.

An “ANT Central Monitoring Station Log” window 1702 can show the current status log of the A.N.T. server actively highlighted in the tree view 1701a. This information can be time and date stamped with the most current date on the bottom. Additionally, the information provided in window 1702 can be similar to the information provided in log entry block 1102 discussed above with reference to FIG. 11. For a larger view of log window 1702, see FIG. 36.

An “ANT Central Monitoring Station BANDWIDTH” chart 1704 can show a Multi-Router Traffic Grapher (MRTG) graph generated on the A.N.T. server highlighted in the tree view 1701a. Through block 1704, the MRTG can poll the router's SNMP data and can chart the relative inbound/outbound bandwidth utilization. By polling the router from the A.N.T. server and passing this SNMP data through A.N.T.'s communications protocol, the SNMP data can be secure from all unauthorized personnel. The information displayed in chart 1704 can be similar to the information displayed in chart 1104 discussed above with reference to FIG. 11.

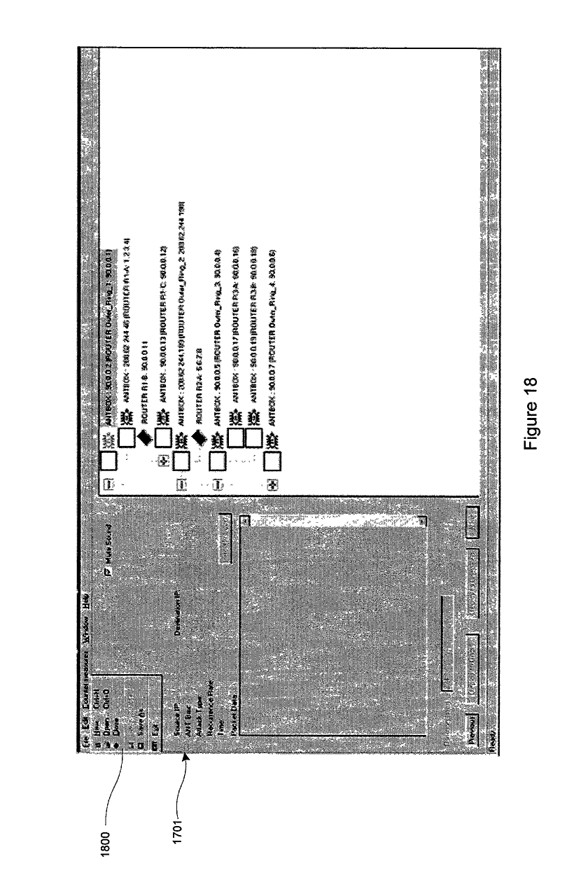

FIG. 18 illustrates exemplary file menu options 1800 referenced by file menu button 1728 of ACMS screen 1701. File menu options 1800 can allow the user to create a new A.N.T. systems tree, open a stored A.N.T. systems tree, close the current tree, save the currently displayed tree data, and exit the A.N.T. control system.

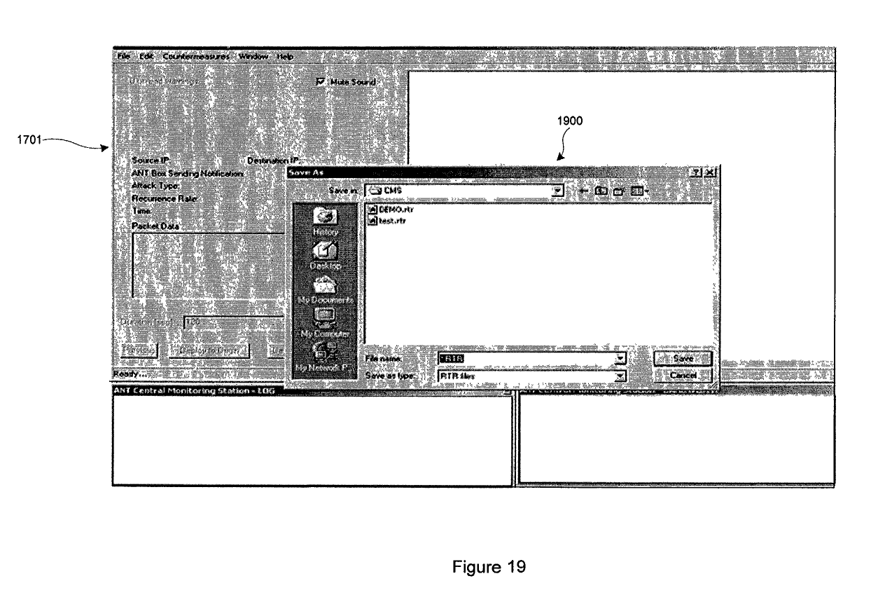

FIG. 19 illustrates an exemplary new file dialog window 1900 referenced by the new menu item of file menu options 1800. The new file dialog window 1900 can allow the user to choose the name of the new tree view that is being created. It can be a standard windows dialog box, which can allow the input of a new filename, which can be saved in a chosen location.

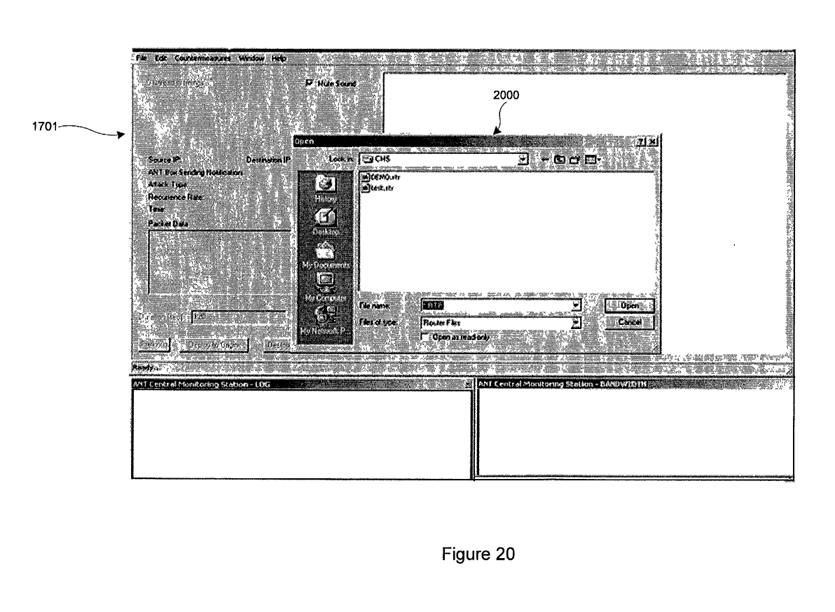

FIG. 20 illustrates an exemplary open dialog window 2000 referenced by the open menu item of file menu options 1800. The open file dialog window 2000 can allow the user to open an A.N.T./router tree view. It can be a standard windows dialog box, which can allow the user to navigate the file system and choose a router .rtr tree file.

The “Close” option of file menu options 1800 can allow closing the tree shown in tree configuration view 1701b of ACMS screen 1701. When clicked, all items in the tree view can be cleared, and the ACMS can allow the opening, or creation, of a .rtr file.

The “Save” option of file menu options 1800 can allow saving of any changes made to tree configuration view 1701b under the currently opened .rtr filename.

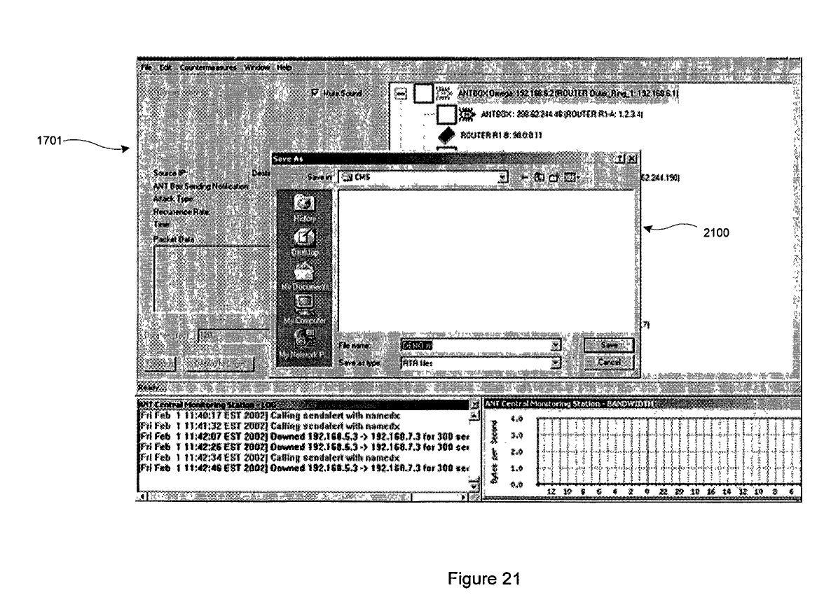

FIG. 21 illustrates an exemplary save as dialog window 2100 referenced by the “Save As” menu item of file menu options 1800. Window 2100 can allow changing the path and filename of an existing tree .rtr file and can allow saving it under a new name.

The “Exit” option of file menu options 1800 can be a common selection term to close out the current display window.

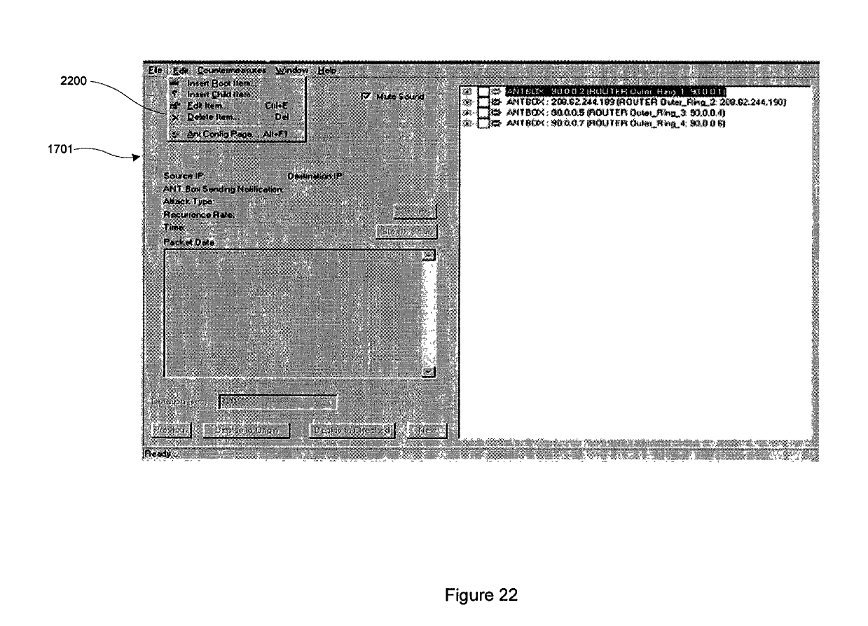

FIG. 22 illustrates exemplary edit menu options 2200 referenced by file menu button 1730 of ACMS screen 1701. Edit menu options 2200 can allow inserting a root and child level item in the tree structure, as well as editing and deleting an item.

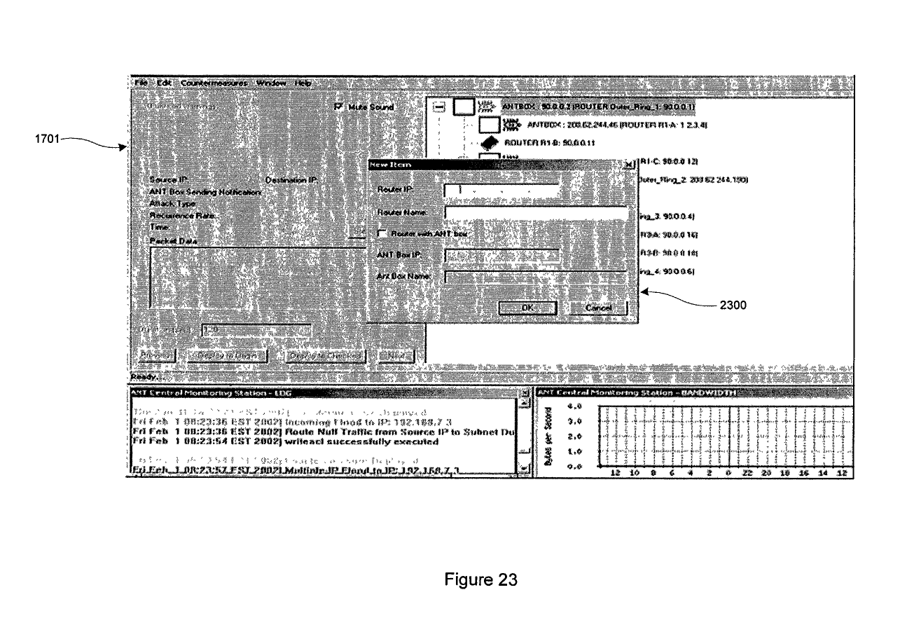

FIG. 23 illustrates an exemplary “Insert Root Item” dialog window 2300 referenced by the “Insert Root Item” menu item of edit menu options 2200. Window 2300 can allow adding a new item at the first level (the root level) of tree configuration view 1701b. All root level items can be at the network border level for quick and easy access to the entire network infrastructure.

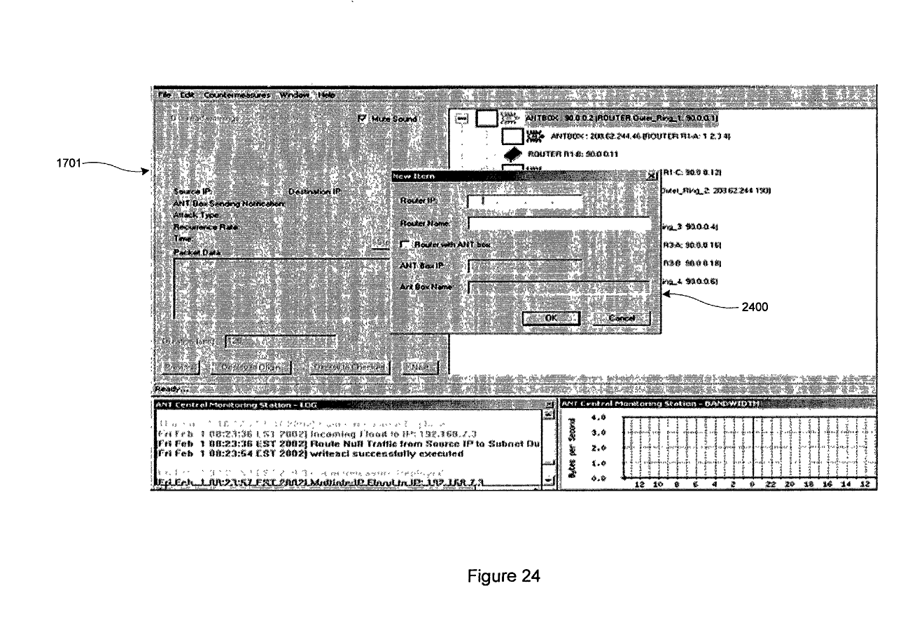

FIG. 24 illustrates an exemplary “Insert Child Item” dialog window 2400 referenced by the “Insert Child Item” menu item of edit menu options 2200. Window 2400 can allow adding a new item below the root level (at the child level). Typically, those items comprise routers and or A.N.T. servers connected to the border routers and down the line. The further right in tree configuration view 1701b, the further the router or A.N.T. server resides from the border router. Such a layout can allow the ability to gain a quick picture of where an attack has been perpetrated within the network. Multiple routers/A.N.T. servers can reside at the same level in tree configuration view 1701b to depict multiple objects at the same level within the network infrastructure.

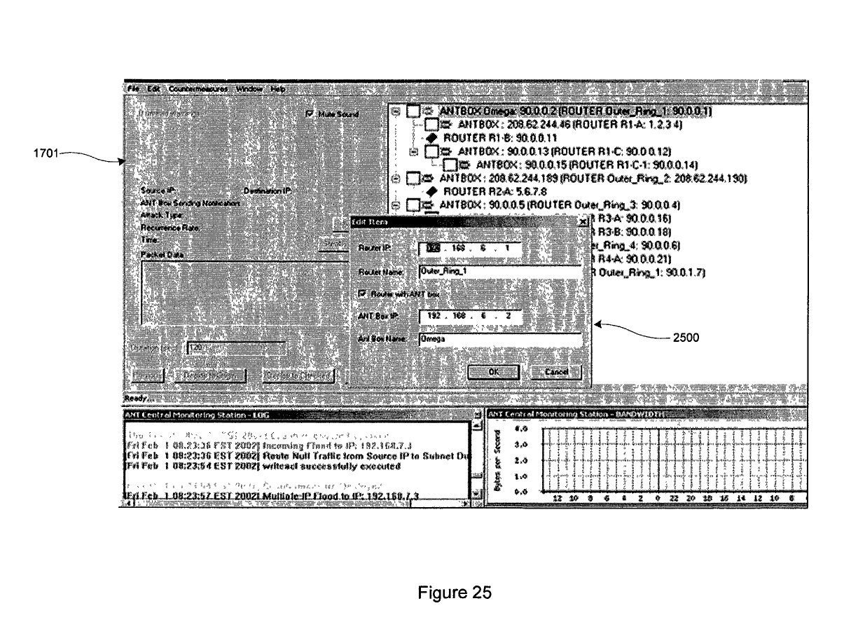

FIG. 25 illustrates an exemplary “Edit Item” dialog window 2500 referenced by the “Edit Item” menu item of edit menu options 2200. Window 2500 can appear when an object in the tree view is selected and the edit item option has be chosen. Window 2500 can allow the ability to modify the existing item in the tree configuration view 1701b.

The “Delete Item” of edit menu options 2200 can allow the user to delete a currently selected item in the tree configuration view 1701b.

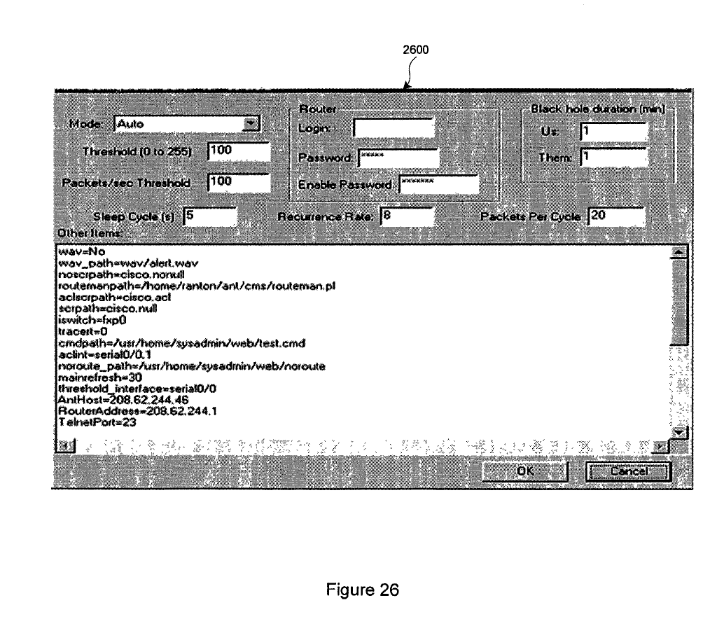

FIG. 26 illustrates an exemplary “Ant Config Page” dialog window 2600 referenced by the “Ant Config Page” menu item of edit menu options 2200. Window 2600 can provide a windows based configuration file editor for an A.N.T. server highlighted in tree configuration view 1701b. The configuration file editor can allow changing the setup options for the currently selected A.N.T. server. All options such as those discussed above with reference to FIGS. 16A and 16B can be displayed in the configuration editor. All items except for passwords to the router(s) can be displayed in plain text and can be modified. The router passwords can be starred out to maintain security, but they can be changed from the editor screen. Window 2700 can include blocks and information similar to configuration screen 1600 discussed above with reference to FIGS. 16A and 16B.

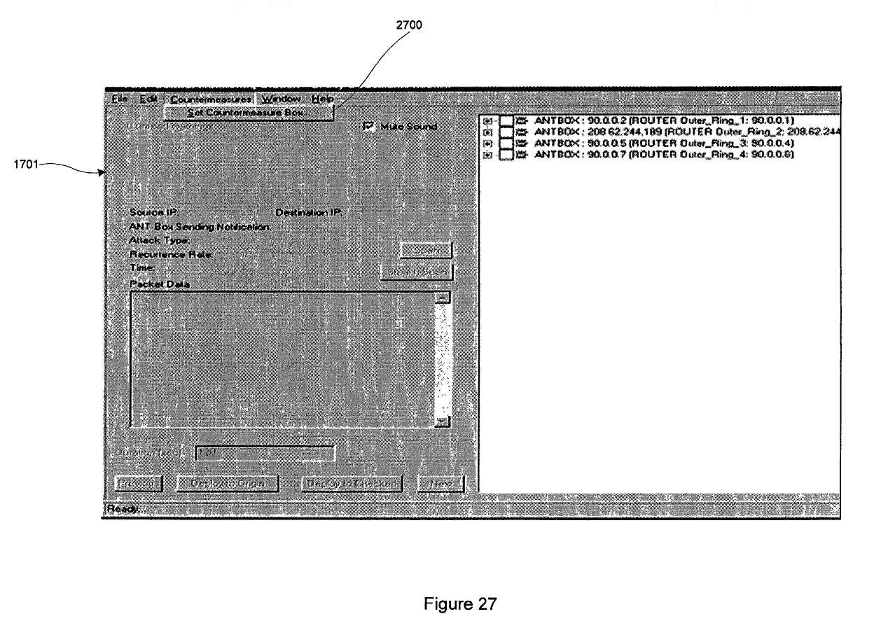

FIG. 27 depicts exemplary countermeasure menu options 2700 referenced by file menu button 1732 of ACMS screen 1701. Window 2700 can allow setting the IP address of a countermeasure server used to scan/probe and gain remote access to an offending system. A separate countermeasure server can be used in order to keep the locations of the A.N.T. servers from being disclosed. That option also can allow entering a username on the countermeasure server for logging and tracking purposes. The use of a separate offensive countermeasure server can be particularly beneficial by hiding the identity of the host network.

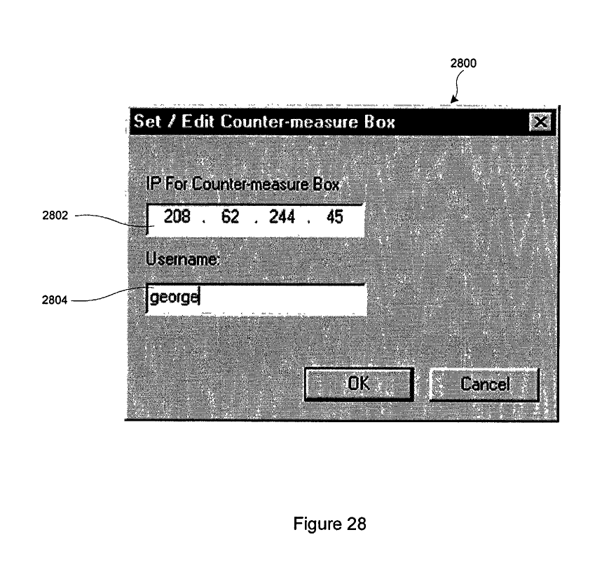

FIG. 28 illustrates an exemplary “Set Countermeasure Box” dialog window 2800 referenced by the “Set Countermeasure Box” menu item of countermeasure menu options 2700. Window 2800 can allow entering an IP address and a username for a countermeasure server in address block 2802 and username block 2804, respectively. The countermeasure server can be the computer that the A.N.T. server will use to scan and attempt to exploit the offending computer.

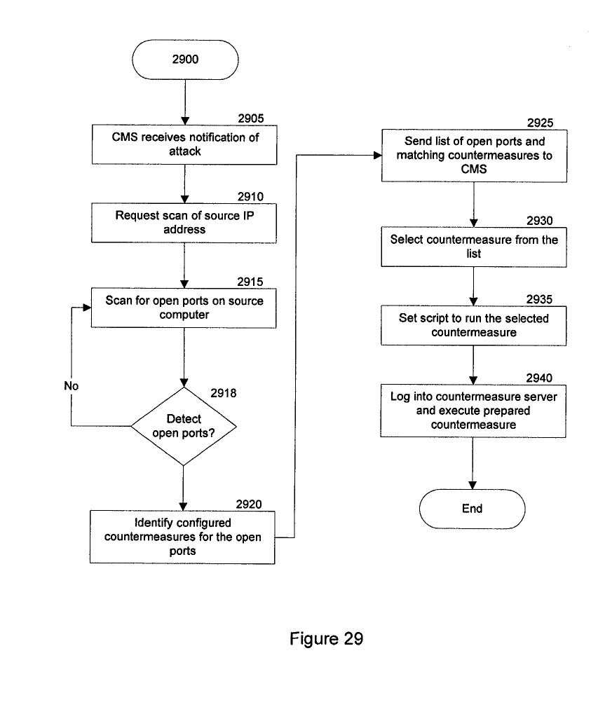

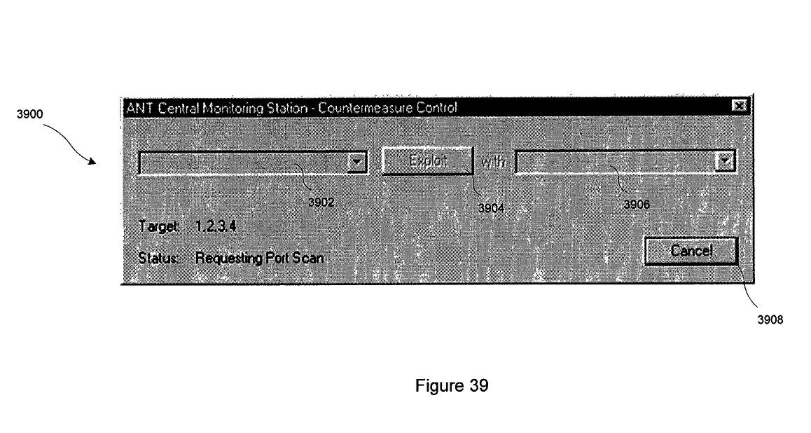

FIG. 29 is a flow chart depicting a method 2900 for secure communications between an A.N.T. server and a countermeasure server according to an exemplary embodiment of the present invention. In step 2905, a CMS can receive notification of an attack. In step 2910, the CMS operator can request from the countermeasure server a scan of open ports on the attacking computer. Upon receipt of this request the countermeasure server can execute a port scan on the attacking computer in step 2915. In step 2918, the countermeasure server can determine if open ports exist on the attacking computer. If not, the method can branch back to step 2915 to continue scanning. If open ports exist, then the method can branch to step 2920. In step 2920, the countermeasure server can identify configured countermeasures for the open ports on the attacking computer. In step 2925, the countermeasure server can return a list of open ports, as well as any installed countermeasures configured for those ports in the CMS countermeasure database. In step 2930, the CMS operator can then view the list of open ports and countermeasures and can choose to deploy a countermeasure by selecting it from the menu and selecting a button (see FIG. 39, discussed below). The CMS can then send that information to the countermeasure server, which prepares a script in step 2935 to run the attack. In step 2940, the CMS operator can login into the countermeasure server machine and run the script to launch an offensive counterattack.

The countermeasure server can be programmed with various exploits and offensive software routines by the end user. The countermeasure server can sit outside the host-protected network and can be located virtually anywhere in the world. When the countermeasure server is located outside the host protected network, the network's identity can be hidden from hostile threats. The countermeasure server can have the ability to launch attacks against a hostile computer posing a threat to the host-protected network. All communications between the ACMS and the countermeasure server can be encrypted with communications and encryption protocols. An example of such protocols is provided in U.S. Provisional Patent Application No. 60/291,815 of Sias, et al., filed May 17, 2001, and entitled “Xtream Management System. The complete disclosure of that provisional application is incorporated herein by reference.

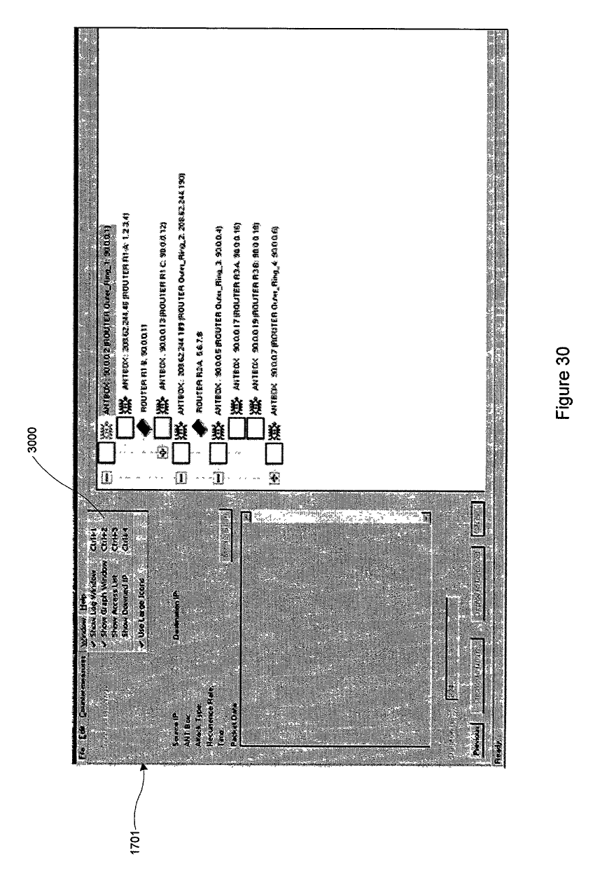

FIG. 30 depicts exemplary window menu options 3000 referenced by window menu button 1734 of ACMS screen 1701. Window menu options 3000 can allow choosing which windows of the A.N.T. control system will be displayed at any time. The user can have a choice of displaying log window 1702, bandwidth utilization chart (MRTG) 1704, the Access List manager, and/or the downed interfaces for any particular router. This menu also can allow the end user to change the size of the icons in the tree view. Under the “Window” option the user has the ability to display any of the ACMS windows that compose the main screen. The Alert and tree views also can be in the main window.

The “Show Log Window” file option can display the log file 1702 of the highlighted item in tree configuration view 1701b in a separate window. That window can be turned on or off by clicking the option under the window options 3000. The “Show Graph Window” option can display the MRTG graph 1704 generated by polling SNMP data from the router by the A.N.T. server.

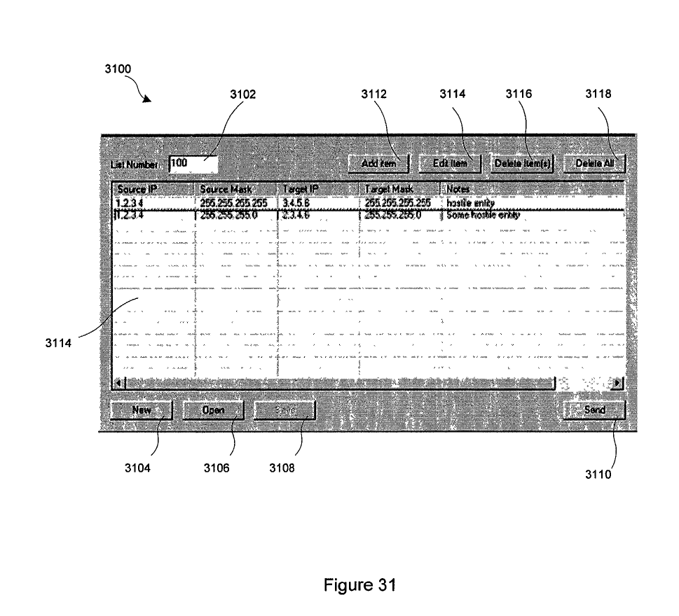

FIG. 31 illustrates an exemplary access control list manager window 3100 referenced by the “Show Access List” option of window menu options 3000. Window 3100 can allow managing access lists and deploying them to a single or multiple routers. The operator can add, edit, or delete any entry or all entries in the access list. The operator can load and save access lists for easy recall and implementation at a later time. Additionally, the operator can easily change the access list “number” for deployment of multiple access lists to a single router. List manager window 3100 can allow the user to create, modify, and delete access lists through an easy to use interface.

As an example, a list number can be shown in a list number block 3102 of the ACMS “Access List” window 3100. Four menu buttons 3104-3110 can allow creating a new list, opening an existing list, saving the current list, and deploying the current list, respectively. Send button 3110 can deploy the list to any router checked in tree configuration view 1701b on the ACMS main screen 1700. “Delete Item(s)” button 3116 and “Delete All” button 3118 can allow deleting a highlighted entry or all entries in tree configuration view 1701b, respectively.

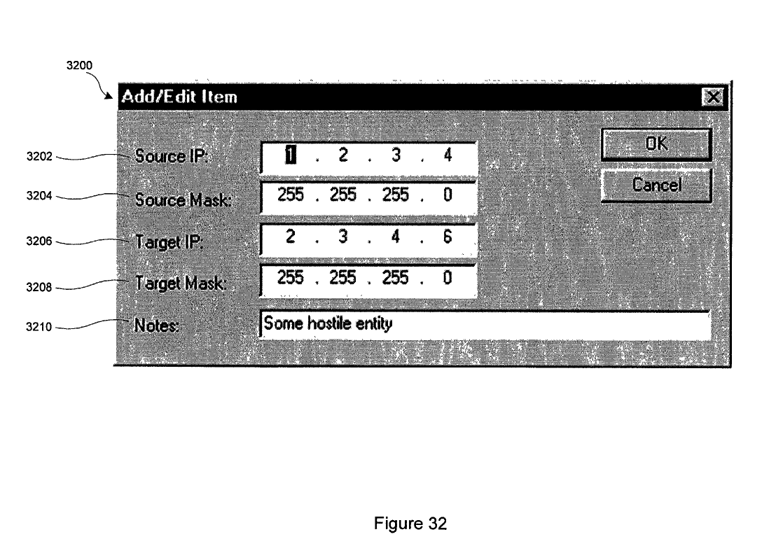

FIG. 32 illustrates an exemplary “Add/Edit Item” dialog window 3200 referenced by the “Add Item” button 3112 or the “Edit Item” button 3114 of access control list manager window 3100. As shown, the following items can be entered or edited in window 3200: Source IP address 3202, Source netmask 3204, Target IP address 3206, Target netmask 3208, and notes 3210. The notes field can provide the operator with an easy reference as to why a particular entry has been implemented.

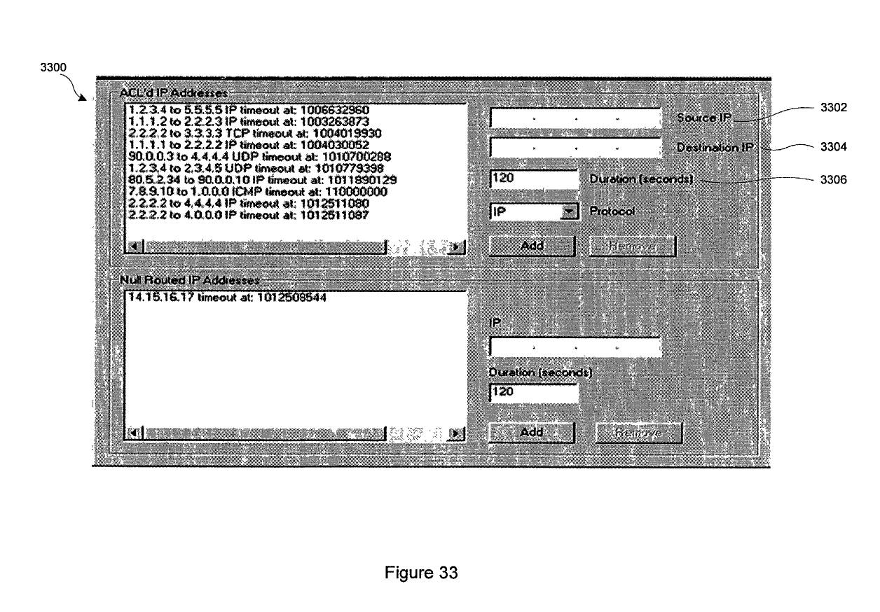

FIG. 33 illustrates an exemplary “Downed IP Editor” 3300 referenced by the “Show Downed IP” option of window menu options 3000. Editor 3300 can allow a system administrator to manually enter a source IP address 3302 and destination IP address 3304, along with a time duration 3306 to take down a network interface. Manual entry can be useful to block certain types of data to a network segment or to take a network interface down at the router level. Editor 3300 can allow the router to block traffic to and from a designated IP address at the discretion of the systems administrator. Editor 3300 can also provide the network administrator the ability to see which IP addresses are not currently connected to the Internet by the host router. The information provided in Editor 3300 can be similar to the information provided in Down Interface screen 1300 discussed above with reference to FIG. 13.

The “Use Large Icons” option of window menu options 3000 can allow changing the size of the items in tree configuration view 1301b from small to large. In this exemplary embodiment, only two size options are available. However, additional size options are not beyond the scope of the present invention.

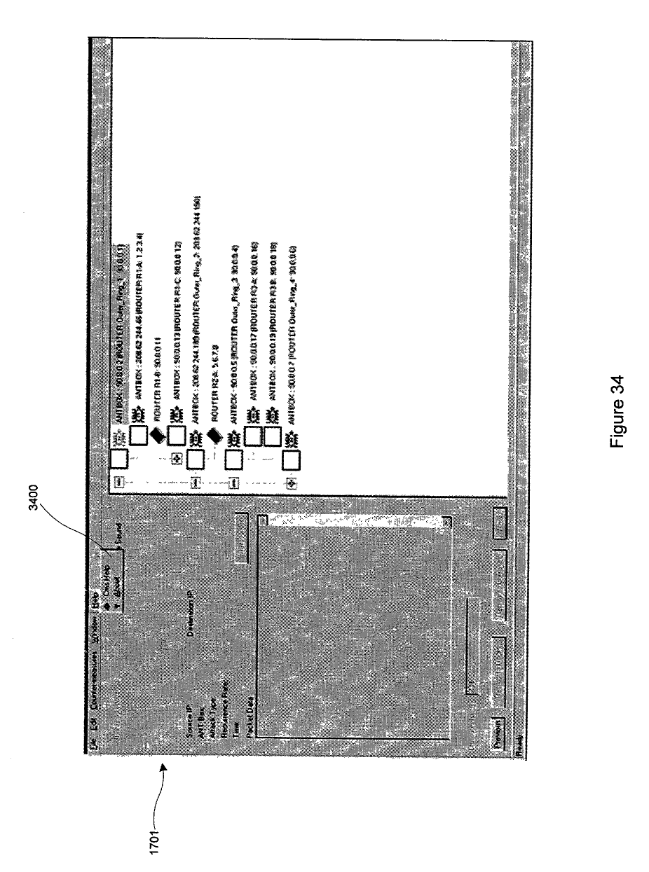

FIG. 34 illustrates exemplary help menu options 3400 referenced by help menu button 1736 of ACMS screen 1701. Help menu options 3400 can allow access to an online version of a user's manual, as well as to screen shots of the A.N.T. system. Under the “Help” pull down menu there can be two options: “Cms Help” and “About.” The “Cms Help” option can be a windows help system that can include a complete A.N.T. user manual for easy and quick reference. That help system can be searched by title, or meta searched by context. The “About” option can provide a short text statement about Cyber Operations and the copyright information.

FIG. 35 illustrates an exemplary “MRTG” graph 1704 of main screen 1700 for the A.N.T. system highlighted in tree configuration view 1701b. Graph 1704 can be generated to show the traffic levels of the router interface directly connected to the uplink router. Graph 3500 can provide information similar to graph 1104 discussed above with reference to FIG. 11. Accordingly, items 1704a-d correspond to items 1104a-d discussed above. Graph 3500 can provide a graphical representation of data throughput on a minute-by-minute basis.

The A.N.T. server can use its own secure communications to transfer these graphs back to the central monitoring system. Once A.N.T. is implemented, no SNMP data can be transferred across the network in an unsecured method. Once all SNMP is secured and limited to the direct connection between the A.N.T. server and the protected router, misconfigured routers are not susceptible to attacks posing as legitimate SNMP data.

FIG. 36 illustrates an exemplary ACMS log window 1702 of main screen 1700 for the A.N.T. system highlighted in tree configuration view 1701b. The information provided in window 1702 can be similar to the information of log history block 1102 discussed above with reference to FIG. 11. The log files can be customized to log any information deemed necessary by the end user. For example, the log files can time-stamp potential threats, attacks, and countermeasure deployments, as well as manual changes to the routing tables or access control lists. All log files can be color-coded. For example, warnings can be gray, incoming floods can be red, countermeasures can be blue, and manually added changes to the router can be logged in yellow.

FIG. 37 illustrates an exemplary ACMS main screen 1700 having an “Alert” message 3702 displayed due to a detected DOS attack. Upon detection of a network flood by the A.N.T. system, “ALERT” message 3702 can flash above the Source IP location 1710 while an audible warning can sound. Placing a check mark in a checkbox 3704 labeled “Mute Sound” can stop the audible warning. An “Unread Warnings” text 3706 can show the number of alert messages waiting to be viewed. When multiple warnings are present, text 3706 can be highlighted in “black.” If no additional “Unread Warnings” are detected, then text 3706 may not be highlighted in black. Each queued unread warnings” can be read by selecting a “Next” button 1724d located in the row of buttons on the bottom left side of the main ACMS screen 1700.

As discussed with reference to FIG. 13, located below the “Alert” message, can be the Source IP 1710, Destination IP 1712, the A.N.T. server that detected the flood 1714, the attack type 1716, the number of offending packets detected 1718, and the time and date of the incoming attack 1720. The text packet data window 1722 can show the captured data packets from the attacking source, which can be stored on the A.N.T. server for later forensic analysis. Four buttons can be provided to allow viewing the last “Previous” attack (Previous button 1724a), deploying a countermeasure to the original A.N.T. box that detected the flood (Deploy to Origin button 1724b), deploying a countermeasure to all A.N.T. boxes checked in tree configuration view 1701b (Deploy to Checked button 1724c), and skipping forward to the next alert message (Next button 1724d).

The tree configuration view 1701b can show the currently deployed A.N.T. servers and routers over which the ACMS has managerial oversight. A checkbox 3710 can be located to the left of each A.N.T. box deployed on the host network. By placing a “check” in checkbox 3710 and clicking deploy to checked button 1724c, the operator can determine which A.N.T. server will respond to the hostile attack. Multiple checked boxes indicates that multiple A.N.T. servers will respond to the attack.

FIG. 38 illustrates an exemplary ACMS main screen 1700 of the windows based Central Monitoring Station having an “Exploit” warning 3802. The Exploit warning can be displayed when an attacker attempts to break into a network machine by launching a remote root exploit. As soon as a hack attempt is made, the A.N.T. server can identify the following: source of the attacker, the target server of hack attempt, and what service on the server that was the target of the attempted hack. A “Stealth Scan” button 3804 can be provided to allow scanning the attacking source computer for potential vulnerabilities. If any potential vulnerability exist, the CMS operator can be given the opportunity to attempt a counter hack or exploit of those identified system vulnerabilities.

FIG. 39 illustrates an exemplary “Countermeasure Control” screen 3900 referenced by stealth scan button 3804. When stealth scan button 3804 is selected, screen 3900 can provide the results from scanning the hostile computer that launched the exploit. The “Stealth Scan” button can launch a routine that can scan an attacking computer for system vulnerabilities. A drop down menu 3902 can provide a list of all services currently running on the hostile computer that have the potential to be exploited. A second drop down menu 3906 can provide a list of exploits that can be used against the particular services listed in drop down menu 3902. Once a service and an exploit are chosen in the specified windows 3902, 3906, an exploit button 3904 can be highlighted to become active. Selecting exploit button 3904 can execute an attempt to gain access to the hostile computer that launched the attack. Exploit button 3904 can securely send a requested action from the ACMS Countermeasure Control screen 3900 to an exploit server such as the offensive countermeasure server to execute the necessary instructions. If successful, the exploit server can open a window and can provide “Root Access” to the hostile computer. If the exploit server is unsuccessful in gaining access to the hostile computer, then the operator can return to the ACMS Countermeasure Control screen 3900 and can select another service from list 3902 and/or another exploit from list 3904. The operator can then try again to gain root access to the hostile computer. That process can be repeated until all combinations of services and exploits are exhausted. A cancel button 3908 can be available for discontinuing the counterattacking initiative.

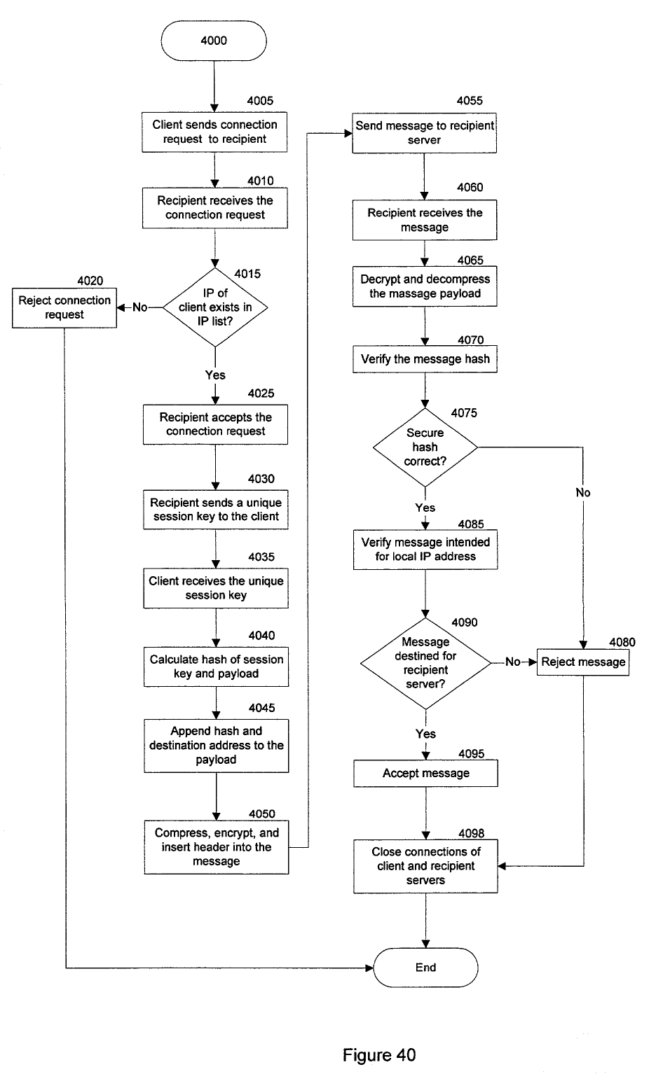

FIG. 40 is a flow chart depicting a method 4000 for secure message communications between the CMS and A.N.T. servers according to an exemplary embodiment of the present invention. Method 4000 can allow the implementation of secure communications in the ANT Central Monitoring Station through an encryption system that can be implemented on any computer network. Although a system using method 4000 can be totally secure, it can be altered to employ a wide array of available encryption methods and secure hashing functions to accommodate the preferences and convenience of the end user. As shown in FIG. 40, method 4000 can include step 4005 in which a client (an A.N.T. server or countermeasure server) can request a connection with the recipient server (the central monitoring station). In step 4010, the recipient server can receive the connection request. In step 4015, the recipient server can determine whether the client's IP address is in a recipient's list of allowed IP addresses. If no, then the method can branch to step 4020, where the connection request can be rejected as the method ends. If the client's IP address is in the recipient's list of allowed IP addresses, then the method can branch to step 4025 in which the recipient server can accept the connection request. The recipient server then can send a unique 8 byte session key back to the client in step 4030. The client can receive the key in step 4035.

In step 4040, the client can calculate a secure hash using the session key and the payload data that it will send to the recipient. In step 4045, the hash and intended recipient information can be attached to the message data. The message can be compressed, encrypted, and addressed with the proper header information in step 4050. Then, the client can send the message to the recipient server in step 4055. In step 4060, the recipient server can receive the payload, which it can decrypt and decompress in step 4065. The recipient server can then verify that the secure hash is correct in step 4070. In step 4075, the recipient server can determine if the secure hash is correct. If the secure hash is not correct, then the method can branch to step 4080 in which the message can be rejected. The method can proceed to step 4098 in which connections of the client and the recipient servers can be closed.

If the secure hash is correct, then the method can branch to step 4085 to verify that the message is destined for the recipient server. In step 4090, the recipient server can determine whether the message is destined for the recipient server. If yes, then the message can be accepted in step 4095. The method can proceed to step 4098 where the connections can be closed. If the message is not destined for the recipient server, then the method can branch to step 4080 where the message can be rejected before proceeding to step 4098.

The present invention can be used with computer hardware and software that performs the methods and processing functions described above. As will be appreciated by those skilled in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments of the present invention have been described above in detail, the description can be merely for purposes of illustration. Various modifications of, and equivalent steps corresponding to, the disclosed aspects of the exemplary embodiments, in addition to those described above, can be made by those skilled in the art without departing from the spirit and scope of the present invention defined in the following claims, the scope of which can be to be accorded the broadest interpretation so as to encompass such modifications and equivalent structures.

What is claimed is:

1. A computer-implemented method for protecting a host network from a flood-type denial of service attack, comprising the steps of:
passively collecting a data packet from data received by the host network, the data packet comprising information indicating the attack;
comparing the information in the data packet to a signature of an attack type of the attack to determine whether the information and the signature comprise matching data; and
detecting the attack in response to a determination that the signature and the information comprise matching data.

2. The method according to claim 1, further comprising the step of providing a pathway for an offensive countermeasure against a source of the attack.

3. The method according to claim 1, further comprising the step of generating the signature for the attack type of the attack.

4. The method according to claim 3, wherein the attack type comprises a plurality of data packets, and
wherein said generating step comprises the steps of:
identifying a repetitive pattern in the plurality of data packets of the attack type; and
storing the repetitive pattern as the signature of the attack type.

5. The method according to claim 3, wherein the information comprises information from a header of the data packet, and
wherein said comparing step comprises comparing the information from the header to the signature.

6. The method according to claim 3, wherein the signature comprises a repetitive pattern of information from data packets of the attack type.

7. The method according to claim 6, wherein the repetitive pattern comprises information included in a header of each data packet of the attack type.

8. The method according to claim 1, further comprising the step of initiating a defensive countermeasure to protect the host network from the attack in response to detection of the attack.

9. The method according to claim 8, further comprising the step of confirming the attack before initiating the defensive countermeasure to protect the host network from the attack.

10. The method according to claim 9, wherein said confirming step comprises the steps of:
setting a load threshold for the host network;
determining the current load on the host network;
determining whether the current load exceeds the load threshold; and
confirming the attack in response to a determination that the current load exceeds the load threshold.

11. The method according to claim 8, further comprising the step of tracing a route of the attack to determine whether a single source produced the attack,
wherein said initiating step comprises initiating a single-source, defensive countermeasure in response to a determination that a single source produced the attack, and
wherein said initiating step comprises initiating a multiple-source, defensive countermeasure in response to a determination that a single source did not produce the attack.

12. The method according to claim 11, wherein said collecting step comprises collecting a plurality of data packets from data received by the host network,
wherein said tracing step comprises comparing information in each of the data packets to determine if the information in each data packet is the same, and
wherein said tracing step determines that a single source produced the attack in response to a determination that the information in each data packet is the same.

13. The method according to claim 12, wherein the information in each data packet comprises a source IP address.

14. A computer-readable medium having computer-executable instructions for performing the steps recited in claim 1.

15. A computer-implemented method for protecting a host network from attack, comprising the steps of:
passively collecting a plurality of data packets from data received by the host network;
comparing information in respective data packets to determine if any pair of the data packets comprise similar information; and
detecting the attack in response to a determination that the pair of data packets comprise similar information.

16. The method according to claim 15, further comprising the step of providing a pathway for an offensive countermeasure against a source of the attack.

17. The method according to claim 15, wherein said comparing step comprises comparing information in the respective data packets to determine if about forty percent of the data packets comprise similar information, and
wherein said detecting step detects the attack in response to a determination that about forty percent of the data packets comprise similar information.

18. The method according to claim 15, wherein the information in the respective data packets comprises a header, and wherein said comparing step comprises comparing the headers of the respective data packets.

19. The method according to claim 15, further comprising the steps of:
setting a load threshold for the host network;
determining the current load on the host network;
comparing the current load to the load threshold; and
confirming the attack when the current load exceeds the load threshold.

20. The method according to claim 15, further comprising the steps of:
determining whether the attack comprises a new attack type; and
learning a new signature of the new attack type in response to a determination that the attack comprises a new attack type.

21. The method according to claim 20, wherein said learning step comprises the steps of:
identifying a repetitive pattern in data from the plurality of data packets of the attack; and
storing the repetitive pattern as the new signature of the new attack type.

22. The method according to claim 21, wherein the data from the plurality of data packets comprises a header for each respective data packet, and
wherein said identifying step comprises identifying a repetitive pattern in the headers of the plurality of data packets of the new attack type.

23. The method according to claim 15, further comprising the step of initiating a defensive countermeasure to protect the host network from the attack in response to detection of the attack.

24. The method according to claim 23, further comprising the step of tracing a route of the attack to determine whether a single source produced the attack,
wherein said initiating step comprises initiating a single-source, defensive countermeasure in response to a determination that a single source produced the attack, and
wherein said initiating step comprises initiating a multiple-source, defensive countermeasure in response to a determination that a single source did not produce the attack.

25. The method according to claim 24, wherein said tracing step comprises comparing a source IP address in each of the data packets to determine if the source IP address in each data packet is the same, and
wherein said tracing step determines that a single source produced the attack in response to a determination that the information in each data packet is the same.

26. A computer-readable medium having computer-executable instructions for performing the steps recited in claim 15.

27. A computer-implemented method for protecting a host network from attack, comprising the steps of:
detecting the attack based on a load capacity of the host network; and
initiating a defensive countermeasure to protect the host network from the attack in response to detection of the attack.

28. The method according to claim 27, wherein said detecting step comprises the steps of:
setting a load threshold for the host network, the load threshold establishing an amount of the load capacity beyond which the attack is indicated;
determining the current load on the host network; and
comparing the current load to the load threshold, wherein said detecting step detects the attack when the current load exceeds the load threshold.

29. A computer-readable medium having computer-executable instructions for performing the steps recited in claim 27.

30. A computer-implemented method for generating a signature of a network attack type, the attack type corresponding to a flood-type denial of service attack comprising a plurality of data packets, said method comprising the steps of:
examining information included in each of the plurality of data packets;
identifying a repetitive pattern in the information of at least two of the plurality of data packets; and
storing the repetitive pattern as a signature of the attack type.

31. The method according to claim 30, wherein the information comprises a header.

32. A computer-readable medium having computer-executable instructions for performing the steps recited in claim 30.

33. A computer-implemented method for countering a flood-type denial of service network attack from a single source, the attack comprising an attacking data packet and the network comprising a host router, said method comprising the steps of:
reading an attacking source IP address from the attacking data packet; and
preventing an incoming data packet comprising the attacking source IP address from entering the host network through the host router.

34. The method according to claim 33, wherein said preventing step comprises the steps of:
determining whether the incoming data packet comprises the attacking source IP address;
rejecting the incoming data packet in response to a determination that the incoming data packet comprises the attacking source IP address; and
accepting the incoming data packet in response to a determination that the incoming data packet does not comprise the attacking source IP address.

35. The method according to claim 34, further comprising the step of writing the attacking source IP address to an access control list of the host router, the access control list identifying a source from which the host router will reject a data packet,
wherein said determining step comprises determining whether the access control list comprises the source IP address of the incoming data packet.

36. The method according to claim 35, further comprising the step of storing the attacking source IP address in an access control file,
wherein said writing step comprises writing the contents of the access control file to the access control list of the host router.

37. The method according to claim 36, further comprising the steps of:
detecting a revised version of the access control file; and
updating the access control list of the host router to correspond to the revised access control file in response to detecting the revised access control file.

38. The method according to claim 35, further comprising the step of applying the access control list to an incoming interface of the host router.

39. The method according to claim 33, further comprising the steps of:
storing a block time for the attacking source IP address, the block time indicating a time period during which said preventing step is performed;
determining whether the block time has expired; and
discontinuing said preventing step in response to a determination that the block time has expired.

40. The method according to claim 35, further comprising the steps of:
storing a block time for the attacking source IP address, the block time indicating a time period during which said preventing step is performed;
determining whether the block time has expired; and
removing the attacking source IP address from the access control list of the host router in response to a determination that the block time has expired.

41. A computer-readable medium having computer-executable instructions for performing the steps recited in claim 33.

42. A computer-implemented method for countering a flood-type denial of service network attack from multiple sources, the attack comprising a plurality of attacking data packets and the network comprising a host router, said method comprising the steps of:
reading an attack target IP address from one of the plurality of attacking data packets; and
preventing an incoming data packet having the attack target IP address from entering the host network through the host router.

43. The method according to claim 42, wherein said preventing step comprises the step of sending the incoming data packet having the attack target IP address to a null interface of the host router.

44. The method according to claim 42, further comprising the steps of:
determining whether the incoming data packet comprises the attack target IP address;
accepting the incoming data packet in response to a determination that the incoming data packet does not comprise the attack target IP address; and
sending the incoming data packet to a null interface of the host router in response to a determination that the incoming data packet comprises the attack target IP address.

45. The method according to claim 44, further comprising the step of automatically updating an upstream router coupled to the host router to direct a data packet destined for the attack target IP address to a null interface of the upstream router.

46. The method according to claim 44, further comprising the step of writing the target IP address to a null route list of the host router, the null route list identifying a target IP address for which a data packet will be sent to the null interface of the host router,
wherein said determining step comprises the step of comparing the target IP address of the incoming data packet to the null route list to determine whether the incoming data packet comprises the attack target IP address.

47. The method according to claim 46, further comprising the step of storing the attacking source IP address in a null route file,
wherein said writing step comprises writing the contents of the null route file to the null route list of the host router.

48. The method according to claim 47, further comprising the steps of:
detecting a revised version of the null route file; and
updating the null route list of the host router to correspond to the revised null route file in response to detecting the revised null route file.

49. The method according to claim 42, further comprising the steps of:
storing a block time for the attack target IP address, the block time indicating a time period during which said preventing step is performed;
determining whether the block time has expired; and
discontinuing said preventing step in response to a determination that the block time has expired.

50. The method according to claim 46, further comprising the steps of:
storing a block time for the attack target IP address, the block time indicating a time period during which said preventing step is performed;
determining whether the block time has expired; and
removing the attack target IP address from the null route list of the host router in response to a determination that the block time has expired.

51. A computer-readable medium having computer-executable instructions for performing the steps recited in claim 42.

52. A system for protecting a host network from a flood-type denial of service attack, the host network comprising a host router, said system comprising:
an interface, coupled to the host router, operable for communicating data packets to and from the host router;
a database operable for storing a signature for an attack type of the attack, the attack type comprising a plurality of data packets;
a packet sniffing module operable for collecting a data packet from data received by the host router, the data packet comprising information indicating the attack; and
a decision module operable for detecting the attack by determining whether the information in the data packet matches the signature stored in the database.

53. The system according to claim 52, wherein said countermeasure module is further operable for providing a pathway for an offensive countermeasure against a source of the attack.

54. The system according to claim 52, further comprising a self-learning module operable for generating the signature by identifying a repetitive pattern in the plurality of data packets of the attack type.

55. The system according to claim 52, wherein the information in the data packet comprises information from a header of the data packet.

56. The system according to claim 52, wherein the signature comprises a repetitive pattern of information in the plurality of data packets of the attack type.

57. The system according to claim 56, wherein the repetitive pattern comprises information included in a header of each data packet of the attack type.

58. The system according to claim 52, wherein said decision module is further operable for confirming the attack before said countermeasure module initiates the defensive countermeasure.

59. The system according to claim 58, wherein said decision module is operable for confirming the attack by determining whether a current network load exceeds a specified load threshold, and
wherein the decision module confirms the attack in response to a determination that the current network load exceeds the specified load threshold.

60. The system according to claim 52, further comprising a countermeasure module operable for initiating a defensive countermeasure to protect the host network from the attack in response to the decision module detecting the attack.

61. The system according to claim 60, further comprising a trace route module operable for tracing a route of the attack to determine whether a single source produced the attack,
wherein said countermeasure module is further operable for initiating a single-source, defensive countermeasure in response to a determination that a single source produced the attack and for initiating a multiple-source, defensive countermeasure in response to a determination that a single source did not produce the attack.

62. The system according to claim 61, further comprising a router daemon module operable for automatically running said trace route module for tracing the route and said countermeasure module for initiating the defensive countermeasure.

63. The system according to claim 61, wherein said packet sniffing module is further operable for collecting a plurality of data packets from data received by the host router, and
wherein said trace route module is further operable for determining that a single source produced the attack by determining whether a source IP address in each data packet is the same.

64. A system for protecting a host network from a flood-type denial of service attack, the host network comprising a host router, said system comprising:
an interface, coupled to the host router, operable for communicating data packets to and from the host router;
a packet sniffing module operable for collecting a plurality of data packets from data received by the host router; and
a decision module operable for detecting the attack by comparing information in respective data packets to determine if any pair of data packets comprise similar information.

65. The system according to claim 64, further comprising a countermeasure module operable for initiating a defensive countermeasure to protect the host network from the attack in response to detection of the attack.

66. The system according to claim 64, wherein the information in the respective data packets comprises information of a header in the respective data packets.

67. The system according to claim 64, wherein said decision module is further operable for confirming the attack by determining whether a current network load exceeds a specified load threshold, and
wherein the decision module confirms the attack in response to a determination that the current network load exceeds the specified load threshold.

68. The system according to claim 64, further comprising a self-learning module operable for determining whether the attack comprises a new attack type and for learning a new signature of the new attack type in response to a determination that the attack comprises a new attack type.

69. The system according to claim 68, further comprising a database, wherein said learning module is further operable for identifying a repetitive pattern in data from the plurality of data packets of the attack and for storing the repetitive pattern in the database as the new signature of the new attack type.

70. The system according to claim 69, wherein the data from the plurality of data packets comprises information in a header of each respective data packet.
